(19) United States
(12) Patent Application Publication
(10) Pub. No.: US 2010/0250477 A1
(43) Pub. Date: Sep. 30, 2010

(54) SYSTEMS AND METHODS FOR OPTIMIZING A CAMPAIGN

(76) Inventor: Shekhar Yadav, Redwood Shores, CA (US)

Correspondence Address: JONES DAY, 222 EAST 41ST ST, NEW YORK, NY, 10017, US

(21) Appl. No.: 12/415,832

(22) Filed: Mar. 31, 2009

(51) Int. Cl. G06F 15/18; G06F 15/16; G06N 5/02

(52) U.S. Cl. 706/14; 709/206; 706/47

(57) ABSTRACT

Systems and methods for optimizing a digital message campaign response are provided where a relationship is discovered between (i) variance in the absence or presence of one or more elements in digital message across a first plurality of digital messages for a first plurality of recipients and (ii) variance in performance of at least one selected response event across the first plurality of recipients. The relationship is used to modify or create a campaign rule that specifies a frequency or range of frequencies for incorporation of an element in digital messages. The campaign rule is used as a basis for determining a frequency of incorporation of an element in a second plurality of digital messages sent to a second plurality of recipients in the campaign. The relationship discovery and campaign rule modification or creation continues on an ongoing basis throughout the campaign and, optionally, after the campaign is completed.

### 1. FIELD OF THE INVENTION

Systems and methods for optimizing a digital message campaign are provided.

### 2. BACKGROUND OF THE INVENTION

Digital messaging (e.g., e-mail, text messages, etc.) is an essential network service. Many digital messaging systems that send digital messages over the Internet use protocols such as simple mail transfer protocol (SMTP), in the case of e-mail, and other protocols when the digital message is other than e-mail, to send digital messages from one server to another. The messages can then be retrieved with a client using services such as post office protocol (POP) or Internet message access protocol (IMAP). Other protocols for sending digital messages that are e-mails include, but are not limited to, POP3, X.400 International Telecommunication Union standard (X.400), and the Novell message handling service (MHS), and extended simple mail transfer protocol (ESMTP). Specifically, X.400 defines a transfer protocol for sending electronic mail between mail servers and is used in Europe as an alternative to SMTP. MHS, which was developed by Novell, is used for electronic mail on Netware networks.

SMTP transports digital messages among different hosts within the transmission control protocol/Internet protocol (TCP/IP) suite. Under SMTP, a client SMTP process opens a TCP connection to a server SMTP process on a remote host and attempts to send mail across the connection. The server SMTP listens for a TCP connection on a specific port, usually port 25, and the client SMTP process initiates a connection on that port. When the TCP connection is successful, the two processes execute a simple request-response dialogue, defined by the SMTP protocol (see RFC 821 STD 10, simple mail transfer protocol, August 1982, for details), in which the client process transmits the mail addresses of the originator and the recipient(s) for a message. When the server process accepts these mail addresses, the client process transmits the e-mail instant message. The e-mail message contains a message header and message text (“body”) formatted in accordance with RFC 822 (RFC822 STD 11, Standard for the format of ARPA—Internet Text Messages, August 1982). Mail that arrives via SMTP is forwarded to a remote server or it is delivered to mailboxes on the local server. On UNIX-based systems, Sendmail is a widely used SMTP server for e-mail. Sendmail includes a POP3 server and also comes in a version for Windows NT. Microsoft Outlook is the most popular mail-agent program on Window-based systems. Similar protocols are used when the digital message is other than e-mail.

The SMTP model (RFC 821) supports both end-to-end (no intermediate message transfer agents “MTAs”) and store-and-forward mail delivery methods. The end-to-end method is used between organizations, and the store-and-forward method is chosen for operating within organizations that have TCP/IP and SMTP-based networks. A SMTP client will contact the destination host's SMTP server directly to deliver the mail. It will keep the mail item from being transmitted until it has been successfully copied to the recipient's SMTP. This is different from the store-and-forward principle that is common in many other electronic mailing systems, where the mail item may pass through a number of intermediate hosts in the same network on its way to the destination and where successful transmission from the sender only indicates that the mail item has reached the first intermediate hop. The RFC 821 standard defines a client-server protocol. The client SMTP is the one which initiates the session (that is, the sending SMTP) and the server is the one that responds (the receiving SMTP) to the session request. Because the client SMTP frequently acts as a server for a user-mailing program, however, it is often simpler to refer to the client as the sender-SMTP and to the server as the receiver-SMTP. A SMTP-based process can transfer electronic mail to another process on the same network or to another network via a relay or gateway process accessible to both networks. An e-mail message may pass through a number of intermediate relay or gateway hosts on its path from a sender to a recipient.

A simple model of the components of the SMTP system is shown in FIG. 1. Systems that send digital messages other than e-mail have similar components. Referring to FIG. 1, users deal with a user agent (UA). Popular user agents for UNIX include Berkeley Mail, Elm, MH, Pine, and Mutt. The user agents for Windows include Microsoft Outlook/Outlook Express and Netscape/Mozilla Communicator. The exchange of e-mail using, for example TCP, is performed by an MTA. One MTA for UNIX systems is Sendmail, and a conventional MTA for Windows is Microsoft Exchange Server 2007. Users normally do not deal with the MTA. It is the responsibility of the system administrator to set up the local MTA. Users often have a choice, however, for their user agent. The local MTA maintains a mail queue so that it can schedule repeat delivery attempts in case a remote server is unable. Also the local MTA delivers mail to mailboxes, and the information can be downloaded by the UA (see FIG. 1). The RFC 821 standard specifies the SMTP protocol, which is a mechanism of communication between two MTAs across a single TCP connection. The RFC 822 standard specifies the format of the electronic mail message that is transmitted using the SMTP protocol (RFC 821) between the two MTAs. As a result of a user mail request, the sender-SMTP establishes a two-way connection with a receiver-SMTP. The receiver-SMTP can be either the ultimate destination or an intermediate one (known as a mail gateway). The sender-SMTP will generate commands, which are replied to by the receiver-SMTP (see FIG. 1).

A typical e-mail delivery process is as follows. Delivery processes for digital messages other than e-mail follow similar scenarios. In the following scenario, Larry at terminal 102 sends e-mail to Martha at her e-mail address: martha@example.org. Martha can review here e-mail at terminal 102. Martha's Internet Service Provider (ISP) uses mail transfer agent MTA 106.

1. Larry composes the message and chooses send using mail user agent (MUA) 108. The e-mail message itself specifies one or more intended recipients (e.g., destination e-mail addresses), a subject heading, and a message body; optionally, the message may specify accompanying attachments.

2. MUA 108 queries a DNS server (not shown) for the IP address of the local mail server running MTA 110. The DNS server translates the domain name into an IP address, e.g., 10.1.1.1, of the local mail server.

3. User agent 108 opens an SMTP connection to the local mail server running MTA 110. The message is transmitted to the local mail server using the SMTP protocol. An MTA (also called a mail server, or a mail exchange server in the context of the Domain Name System) is a computer program or software agent that transfers electronic mail messages from one computer to another. Webster's New World Computer Dictionary, tenth edition, Wiley Publishing Inc., Indianapolis, Ind., defines an MTA as an e-mail program that sends e-mail messages to another message transfer agent. An MTA can handle large amounts of mail, can interact with databases in many formats, and has extensive knowledge of the many SMTP variants in use. Examples of high-throughput MTA systems are disclosed in U.S. patent application Ser. No. 10/857,601, entitled “Email Delivery System Using Metadata,” filed May 27, 2004 as well as U.S. patent application Ser. No. 10/777,336, entitled “Email Using Queues in Non-persistent memory,” filed Feb. 11, 2004, each of which is hereby incorporated by reference in its entirety. One example of an MTA system is the StrongMail MTA (Redwood Shores, Calif.). Conventional MTA programs include, but are not limited to, Sendmail, qmail, Exim, Postfix, Microsoft Exchange Server, IMail (Ipswitch, Inc.), MDaemon (Alt-N Technologies), MailEnable, Merak Mail Server, and qmail.

4. MTA 110 queries a DNS server (not shown) for the MX record of the destination domain, e.g., example.org. The DNS server returns a hostname, e.g., mail.example.org. MTA 110 queries a DNS server (not shown) for the A record of mail.example.org, e.g., the IP address. The DNS server returns an IP address of, for example, 127.118.10.3. 5. MTA 110 opens an SMTP connection to the remote mail server providing e-mail service for example.org which is also running MTA 106. The message is transmitted to MTA 106 from MTA 110 using the SMTP protocol over a TCP connection.

5. MTA 106 delivers Larry's message for Martha to the local delivery agent 112. Local delivery agent 112 appends the message to Martha's mailbox. For example, the message may be stored in (e.g., using a sample file path on a UNIX system): /var/spool/mail/martha.

6. Martha has her user agent 114 connect to her ISP. Martha's user agent 114 opens a POP3 (Post Office Protocol version 3, defined in RFC1725) connection with the POP3 (incoming mail) server 112. User agent 114 downloads Martha's new messages, including the message from Larry.

7. Martha reads Larry's message.

The MTA 110, which is responsible for queuing up messages and arranging for their distribution, is the workhorse component of electronic mail systems. The MTA “listens” for incoming e-mail messages on the SMTP port, which is generally port 25. When an e-mail message is detected, it handles the message according to configuration settings, that is, the settings chosen by the system administrator, in accordance with relevant standards such as Request for Comment documents (RFCs). Typically, the mail server or MTA must temporarily store incoming and outgoing messages in a queue, the “mail queue.” Actual queue size is highly dependent on one's system resources and daily volumes.

In some instances, referring to FIG. 2, communication between a sending host (client) and a receiving host (server), could involve relaying. In addition to one MTA at the sender site and one at the receiving site, other MTAs, acting as client or server, can relay the electronic mail across the network. This scenario of communication between the sender and the receiver can be accomplished through the use of a digital message gateway, which is a relay MTA that can receive digital messages prepared by a protocol other than SMTP and transform it to the SMTP format before sending it. The digital message gateway can also receive digital messages in the SMTP format, change it to another format, and then send it to the MTA of the client that does not use the TCP/IP protocol suite. In various implementations, there is the capability to exchange mail between the TCP/IP SMTP mailing system and the locally used mailing systems. These applications are called digital message gateways or mail bridges. Sending digital messages (e.g., e-mail) through a digital message gateway may alter the end-to-end delivery specification, because SMTP will only guarantee delivery to the mail-gateway host, not to the real destination host, which is located beyond the TCP/IP network. When a digital message gateway is used, the SMTP end-to-end transmission is host-to-gateway, gateway-to-host or gateway-to-gateway; the behavior beyond the gateway is not defined by SMTP.

Due to their convenience and popularity, e-mails have become a major channel for communications amongst individuals and businesses. Since e-mails can be used to reach a much wider audience in a short period of time, e-mails have also been utilized regularly as a tool in marketing campaigns. There are a number of e-mail marketing companies which have established a market for tracked e-mail campaigns. These companies provide feedback to the e-mail sender when an e-mail was opened by its intended recipient. In some instances, this is accomplished via the inclusion of a ‘web beacon’ (or a single-pixel gif) which is uniquely coded and linked to the particular recipient of the e-mail. In some instances, in order to generate and send e-mails for a tracked campaign, an end user goes through a multi-step workflow that typically includes: (1) recipient list creation/selection—loading into a mass-mail tool a list of possible recipients and creating a recipient list containing selected recipients for a particular campaign; (2) template authoring—using the mass-mail tool to author the HTML email according to one or more predefined templates; and (3) mail merge and execution (send)—merging the recipient list into the predefined templates, thereby creating separate e-mails which contain unique tracking codes in the form of references to an image on a remote server. These e-mails are then sent by a mail bursting engine. When the recipient opens the e-mail in an HTML-enabled e-mail client, the e-mail client contacts the remote server to retrieve the desired image. Because each image is uniquely coded, the remote server is able to track when the e-mail intended for a particular recipient was opened.

Methods for optimizing e-mail marketing campaigns are available. For example, United States Patent Publication No. 2006/0253537 A1 to Thomas (hereinafter, “Thomas”) discloses a method for sending a marketing message in the form of an e-mail to recipients, electronically tracking at least one selected response event occurring as the e-mail is being sent to targeted recipients, and automatically modifying the e-mail that is subsequently sent to targeted recipients in the campaign by changing elements in the e-mail based upon the tracked selected response event. The drawback with this method is that it does not dynamically determine which variables affect the success of an e-mail campaign. Consider a scenario in which the target is to maximize the percentage of time the sent e-mail is opened by recipients. Does the age of the recipients affect this target? Does what appears on the subject line affect this target? Is there some interdependence between age and what is on the subject line that affects this target? Thomas simply does not address these questions. In fact, Thomas makes no effort whatsoever to dynamically segment the recipient population and optimize what is sent to each portion of the recipient population.

In another example, U.S. Pat. No. 7,130,808 B1 to Ranka et al. (hereinafter Ranka) discloses a method for reading a prior stage message state pertaining to a prior stage in a message campaign, reading message performance results representing message trials and message successes from the prior stage, computing a current message state on the basis of the prior stage message state and the message performance results, and generating a current message allocation based on the current message state. As in the case of Thomas, the drawback with Ranka is that it does not dynamically determine which variables affect the success of an e-mail campaign. As in the case of Thomas, consider a scenario in which the target is to maximize the percentage of time the sent e-mail is opened by recipients. Does the age of the recipients affect this target? Does what appears on the subject line affect this target? Is there some interdependence between age and what is on the subject line that affects this target? Ranka, like Thomas, simply does not address these questions. In fact, Ranka makes no effort whatsoever to dynamically segment the recipient population and optimize what is sent to each portion of the recipient population.

Given the above background, what is needed in the art are improved systems and methods for optimizing e-mail campaigns.

Discussion or citation of a reference herein will not be construed as an admission that such reference is prior to the present invention.

### 3. SUMMARY OF THE INVENTION

The present invention addresses the need for improved systems and methods for optimizing digital message campaigns. Exemplary digital messages include, but are not limited to, multimedia message service (MMS) messages, enhanced message service (EMS) messages, short message service (SMS) messages, e-mail, Internet-based instant messaging service (IMS) messages, and exchange instant messaging (EIM) messages, to name a few.

Disclosed are systems and methods for optimizing a digital message campaign response in which a relationship is discovered between (i) the variance in the absence or presence of one or more elements in digital messages across a first plurality of digital messages for a first plurality of recipients and (ii) the variance in performance of at least one selected response event across the first plurality of recipients. The discovered relationship is used to modify or create a campaign rule that specifies a frequency or range of frequencies for incorporation of an element in a plurality of digital messages. The campaign rule is used as a basis for determining a frequency of incorporation of an element in a second plurality of digital messages sent to a second plurality of recipients in the campaign. In some embodiments, the relationship discovery as well as campaign rule modification or creation continues on an ongoing basis throughout the campaign and in some instances after the campaign.

The present invention further provides for target population discovery and/or validation based on an evaluation of user activity. For example, consider the case in which a population of targeted recipients is selected and targeted with offers for Spring styles from a predetermined retailer. The campaign is delivered, in the form of digital messages, to a portion (e.g., ten percent) of the population. The performance of a response event is measured among this portion of the population upon or after delivery of the digital messages. Based on the performance of the response event (e.g., clicks, purchases, downloads, etc.) the following exemplary relationships can be discovered using the disclosed methods:
(1) digital messages with a bright yellow background are more popular (are associated with better performance of a response event) than digital messages with a bright red background,
(2) zip code 94065 has more activity than zip code 94061, and
(3) zip code 94065 peak activities are during day time while zip code 94061 peak activities are in the evening.

Relationship discovery (1) is identified, for example, by correlating variance in the background color of the digital message with variance in performance of the response event across the first portion of the population. Relationship discovery (2) is identified, for example, by segregating the first portion of the population based on zip code and comparing the performance of the response event by members of the first population from each zip code using, for example, a t-test. Relationship (3) is discovered, for example, by segregating the first portion of the population based on zip code as well as by a particular time range when the digital message was sent to the target recipients in the first portion (e.g., night, day, afternoon), and comparing the performance of the response event of each such segregated group (e.g., zip code 1 during day, zip code 1 during night, zip code 2 during day, zip code 2 during night, etc.) again using a t-test or some other form of analysis.

In response to discovery relationship (1), digital messages that are sent to remaining portions of the target population will be up-weighted for a bright yellow background, meaning that a higher percentage of the digital messages sent to the remaining portions of the population will have a yellow background relative to the percentage of digital messages having a yellow background sent to the first portion of the population.

In response to the discovery of relationship (2), those targeted recipients having the demographic “zip code 94065” (meaning that the targeted recipients live in the 94065 zip code) will be tagged with a new attribute, “highly active”. This attribute is now reusable in new campaigns. For example, it might be later on correlated with other attributes, for example, age. In fact, the correlation between the new attribute, “highly active”, and age can be found by reexamination of the first portion of the campaign. For example, with the discovery of the importance of the 94065 zip code, a correlation between this zip code and the age of those targeted recipients in the 94065 zip code can be made. This correlation can be made in several different ways. In one approach, the profiles (demographics) of those targeted recipients in the first portion of the population that are in the 94065 zip code are queried to determine their age. In another approach, a determination can be made to see whether the correlation between the 94065 zip code and the performance of the selected response event is correlated conditional upon recipient age. If, for example, the correlation between the 94065 zip code and the performance of the response event improves when recipient age is factored in, then a correlation between the 94065 zip code and age can be presumed. Alternatively, the correlation between the new attribute, “highly active”, and age can be found by examination of the performance of the response event of another portion of the population.

The disclosed techniques can also be used for the verification of a suitable target population for a campaign. For example, one embodiment provides a method in which there is (i) the discovery of new attributes based on user behavior (e.g. that a particular zip code is correlated with positive performance of a response event), (ii) the subsequent discovery of a correlation of the new attribute to existing attributes (e.g. correlation of this zip code to age), and (iii) the use of the correlation between the new attribute and known attributes to verify a suitable target population based on their user behavior. For example, consider the case where assessment of a first portion of a target population reveals that the 18 to 25 age group is highly correlated with performance of a response event (e.g., purchasing articles). For instance, those in the 18 to 25 age group are very likely to respond to a digital message in a campaign. Then, an evaluation of the 18 to 25 age group determines there is a correlation between this age group and purchasing the ECKO label. This information can be used to verify a new target or a new target population. The new target population asserts that they are in the 18 to 25 age group. However, evaluation of the target population reveals that they are not purchasing the ECKO label. From this, it can be concluded that the members of the new target population are not in the 18 to 25 age group. Of course, the converse may be true, where the new target population asserts that they are in the 18 to 25 age group and evaluation of the target population reveals that they are purchasing the ECKO label thus confirming the age group of the target population.

Regarding relationship (3) above, knowing that the 94065 zip code is more active during the day time, digital messages may be targeted to this zip code in the day time. Knowing that the zip code 94061 is more active in the evening, digital messages may be targeted to this zip code in the day time. In another example, the demographic, rather than being a zip code, can be any combination of an income of a targeted recipient, a gender of a targeted recipient, a health status of a targeted recipient, a location (e.g., state, city, town, street, etc.) of a targeted recipient (in addition or instead of the zip code example already provided), an internet connection speed used by a targeted recipient, a political association of a targeted recipient, a marital status of a targeted recipient, or a connection type (e.g., SMS, MMS, EMS, e-mail, IMS, EIM, etc.) used by the targeted recipient to receive digital messages, to name a few.

### 4. BRIEF DESCRIPTION OF THE DRAWINGS

FIG. 1 is the basic simple mail transfer protocol (SMTP) model in accordance with the prior art.

FIG. 2 is the simple mail transfer protocol (SMTP) model with relay mail transfer agents in accordance with the prior art.

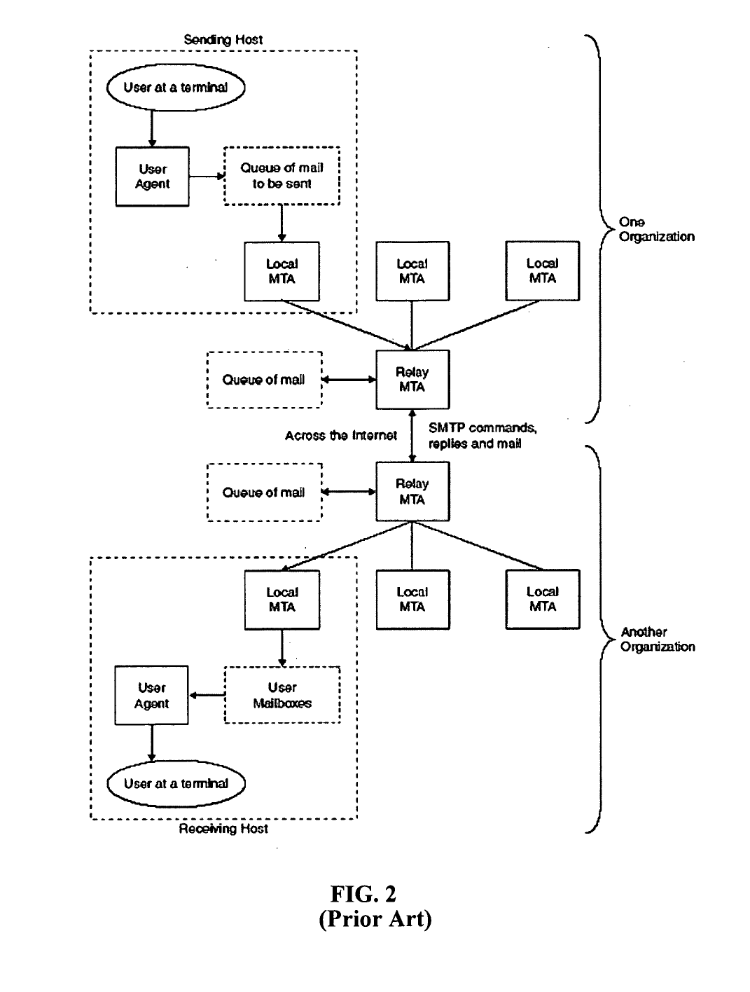

FIG. 3 is a server for optimizing a response of a computer based digital message campaign using computer based processing in accordance with some embodiments.

FIG. 4 outlines processing steps for optimizing a response of a computer based digital message campaign using computer based processing in accordance with some embodiments.

Like reference numerals refer to corresponding parts throughout the several views of the drawings.

### 5. DETAILED DESCRIPTION

The present invention is directed to systems and methods for optimizing a response of a computer based digital message campaign using computer based processing. A first plurality of digital message addresses of a first plurality of targeted recipients are electronically accessed from one or more data structures containing digital message addresses (e.g., e-mail addresses) of the first plurality of targeted recipients. A first plurality of digital messages (e.g., marketing messages in the form of e-mail) is created.

Each digital message in the first plurality of digital messages comprises a plurality of elements independently selected from a library of elements based on one or more campaign rules. Examples of elements include, but are not limited to, a predetermined subject line, a text message, a graphic, a clickable hyperlink, a position of a text message in a digital message, a position of a graphic in a digital message, a position of a clickable hyperlink in a digital message, a background color of a digital message, a font used in a digital message, a point size for text in a digital message, a video clip, a position of a video clip in a digital message, a quality of a video clip in a digital message, or a compression format of a video clip in a digital message.

An example of a campaign rule is to require that a particular element in the library of elements be incorporated into a plurality of digital messages with a predetermined frequency or frequency range. For instance, in the case where the element is a subject line of a digital message (in those digital messages that have a subject line), a given campaign rule may require that a particular subject line (e.g., “Sale starts Thursday”) be used in at least forty percent of the digital messages in the plurality of digital messages. In another example, a given campaign rule may require that a particular subject line (e.g., “Sale starts Thursday”) be used in between forty percent and eighty percent of the digital messages in the plurality of digital messages.

The first plurality of digital messages is sent from a server, such as an e-mail server, over an electronic network to the first plurality of digital message addresses of the first plurality of targeted recipients. In some embodiments, the first plurality of digital messages is sent using a digital message server (e.g., a mail transfer agent (MTA)) (or plurality of servers). In some embodiments, the server (or plurality of servers) optionally keeps a profile for each domain (or site) or set of domains (or set of sites) to which the server (or plurality of servers) routinely sends digital messages.

Each respective optional profile contains one or more parameters that dictate the conditions under which digital messages can be sent to the domain (or site) associated with the respective optional profile (e.g., number of digital message per day, etc.). The digital message server provides digital message service using any available electronic means such as, for example, SMTP, POP3, X.400, ESMTP or MHS protocol or a logical variant thereof (e.g., a program similar to or derived from SMTP, POP3, X.400, ESMTP or MHS). For a general reference regarding digital message protocols, see Hughes, 1998, Internet E-mail: Protocols, Standards, and Implementation, Artech House Publishers, which is hereby incorporated herein by reference herein in its entirety.

Upon receipt of the digital messages, the digital message server determines destination domain (or site) for the digital messages. The digital message server then optionally reads the optional profile for the destination domain (or site) and determines what rules apply for sending the digital messages to the destination domains (or site). If permitted by the optional profile, the digital message server sends the digital message to the destination domain. The digital message server further optionally monitors progress sending digital messages to destination domains (or destination sites).

At least one selected response event occurring after the first plurality of digital messages is sent to the first plurality of digital message addresses of the first plurality of targeted recipients is electronically tracked. Examples, of response events include, but are not limited to a deliverability rate, an digital message open rate, a click through rate, a conversion rate, a purchase rate, a reply rate, and an unsubscribe rate.

Next, in some embodiments, the library of elements is segmented based upon one or more relationships between (i) differences in usages of elements in the first plurality of digital messages and (ii) the at least one selected response event, thereby discovering a relationship result. These one or more relationships are discovered by analysis of the first plurality of digital messages as disclosed in more detail below.

In some embodiments, a determination is made as to whether (i) a variation in the presence or absence of a first element across the first plurality of digital messages and (ii) a variation in the performance of the at least one selected response events across the first plurality of targeted recipients are correlated conditional on a variation in one or more demographics across the first plurality of targeted recipients. For example, consider the case where:
1) the absence or present of a particular digital message and the variation in the performance of the at least one selected response event are highly correlated for those digital messages sent to recipients that are age fifty or older, and
2) the absence or present of a particular digital message and the variation in the performance of the at least one selected response event are not correlated at all for those digital messages sent to recipients that are less than fifty years of age.
   In this example, the (i) a variation in the presence or absence of a first element across the first plurality of digital messages and (ii) a variation in the performance of the at least one selected response events across the first plurality of targeted recipients are correlated conditional on the age of targeted recipients (over fifty or under fifty). In this simple example, the demographic is treated as a categorical variable for the sake of illustration. However, there is no requirement that the demographic be a categorical variable. Rather, in some embodiments, the embodiment is a quantitative variable (e.g., absolute age of recipient as opposed to an age category such as greater or less than 50).

The discovered relationships or discovered correlation conditional relationships described above are used in some embodiments to modify at least one of the one or more campaign rules for the campaign based upon the relationship result. In some embodiments the modification is done without human intervention (e.g., automatically). In some embodiments the modification is done with human intervention (e.g., not automatically).

The discovered relationships or discovered conditional correlation relationships described above are used in some embodiments to create a campaign rule to be added to the one or more campaign rules for the campaign. In some embodiments this is done without human intervention (e.g., automatically). In some embodiments this is done with human intervention (e.g., not automatically).

Next, a second plurality of digital message addresses of a second plurality of targeted recipients is electronically accessed from one or more data structures containing digital message addresses of a second plurality of targeted recipients. A second plurality of digital messages is created. Each digital message in the second plurality of digital messages comprises a plurality of elements independently selected from the library of elements based on the one or more campaign rules which have now been modified as described above.

The second plurality of digital messages is sent from an e-mail server over an electronic network to the second plurality of digital message addresses of the second plurality of targeted recipients. In some embodiments, this relationship discovery and campaign rule modification or creation continues on an ongoing basis throughout the campaign. In some embodiments, this relationship discovery and campaign rule modification or creation continues on an ongoing basis throughout the campaign and after the campaign.

As used herein, the term “correlation” is used to mean any statistically significant relationship. The correlation can be found by computation of a distance metric, or by performing other forms of tests, such as t-test, regression, and any of the other pattern classification techniques disclosed herein and known to those of skill in the art. In some embodiments, there is a correlation if such a test discloses a result that has a p value of 11 or less 0.05 or less, 0.001 or less or 0.0001 or less. However, many of the tests disclosed herein do not necessarily provide a p value and in such instances a correlation is deemed to exist using any art recognized metric and threshold for such tests. As such, the term “correlation”, in preferred embodiments, is not limited to the computation of a correlation coefficient or other similarity metric.

### 5.1 Exemplary Systems

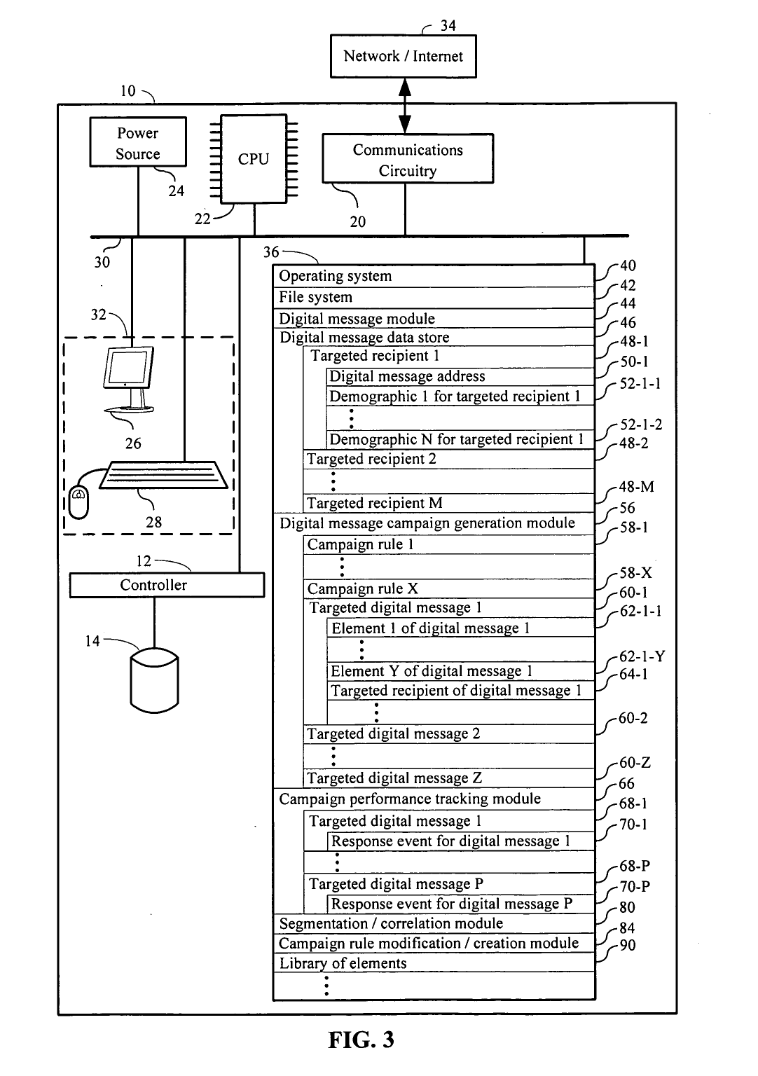

Now that an overview has been provided, an exemplary system that supports the functionality described above is provided in conjunction with FIG. 3. The system is preferably a computer system 10 having:
a central processing unit 22;
a main non-volatile storage unit 14, for example, a hard disk drive, for storing software and data, the storage unit 14 controlled by controller 12;
a system memory 36, preferably high speed random-access memory (RAM), for storing system control programs, data, and application programs, comprising programs and data loaded from non-volatile storage unit 14; system memory 36 may also include read-only memory (ROM);
a user interface 32, comprising one or more input devices (e.g., keyboard 28) and a display 26 or other output device;
a network interface card 20 or other communication circuitry for connecting to any wired or wireless communication network 34 (e.g., the Internet or any other wide area network);
an internal bus 30 for interconnecting the aforementioned elements of the system; and
a power source 24 to power the aforementioned elements.

Operation of computer 10 is controlled primarily by operating system 40, which is executed by central processing unit 22. Operating system 40 can be stored in system memory 36. In addition to operating system 40, in a typical implementation, system memory 36 can include one or more of the following:
file system 42 for controlling access to the various files and data structures;
a digital message (e.g. transfer agent (MTA)) module 44 for processing a plurality of digital messages that are being sent to recipients at a plurality of destination domains (or sites);
a digital message data store 46, which can comprise one or more data structures, for storing information about a plurality of targeted recipients 48, for each of the respective targeted recipients 48, the digital message data store 46 storing a digital message address 50 (e.g., e-mail address) and, optionally, one or more demographics 52 about the respective targeted recipient 48;
a marketing campaign generation module 56 for creating a plurality of digital messages (e.g., e-mails with a destination e-mail address) 60, each digital message 60 in the plurality of digital messages comprising a plurality of elements 62 independently selected from a library of elements based on one or more campaign rules, and each respective digital message 60 in the plurality of digital messages having a targeted recipient 64;
a campaign performance tracking module 66 for electronically tracking at least one selected response event 70 occurring after a plurality of digital messages 60 is sent to a plurality of digital message addresses 68 of a plurality of targeted recipients 64;
a segmentation/correlation module 80 for (A) segmenting a library of elements 90 based upon one or more relationships between (i) differences in usages of elements 62 in a plurality of digital messages and (ii) the at least one selected response event 70, thereby discovering a relationship result or (B) determining whether (i) a variation in the presence or absence of a first element or a first combination of elements across a plurality of digital messages 60 and (ii) a variation in the performance of the at least one selected response event 70 across a plurality of targeted recipients 64 are correlated conditional on a variation in the one or more demographics 52 across the plurality of targeted recipients 64;
a campaign rule modification/creation module 84 for modifying at least one campaign rule 58 of the one or more campaign rules for a campaign based upon a relationship result derived by the segmentation/correlation module 80 and/or for creating a campaign rule 58 to be added to the one or more campaign rules for a campaign; and
a library elements 90, each element in the library of elements 90 specifying, for example, a predetermined subject line, a text message, a graphic, a clickable hyperlink, a position of a text message in a digital message, a position of a graphic in a digital message, a position of a clickable hyperlink in a digital message, a background color of a digital message, a font used in a digital message, a point size for text in a digital message, a video clip, a position of a video clip in a digital message, a quality of a video clip in a digital message, or a compression format of a video clip in a digital message.

As illustrated in FIG. 3, computer 10 comprises software program modules and data structures. The data structures stored in computer 10 include, for example, digital message data store 46 and the library of elements 90. Each of these data structures can comprise any form of data storage including, but not limited to, a flat ASCII or binary file, an Excel spreadsheet, a relational database (SQL), or an on-line analytical processing (OLAP) database (MDX and/or variants thereof). In some embodiments, the information in digital message data store 46 and library of elements 90 are each a single data structure. In some embodiments, digital message data store 46 and/or library of elements 90, in fact, comprises a plurality of data structures (e.g., databases, files, archives) that may or may not all be hosted by computer 10. For example, in some embodiments, digital message data store 46 and/or library of elements 90 comprises a plurality of structured and/or unstructured data records that are stored either on computer 10 and/or on computers that are addressable by computer 10 across network/Internet 34.

In some embodiments, digital message data store 46 and/or library of elements 90 are in a database that is either stored on computer 10 or are distributed across one or more computers that are addressable by computer 10 by network/Internet 34. Thus, in some embodiments, one or more of such data structures is hosted by one or more remote computers (not shown). Such remote computers can be located in a remote location or in the same room or the same building as computer 10. In some embodiments, the software modules illustrated in FIG. 3 are stored in computer 10. In some embodiments, all or a portion of one or more of the software modules illustrated in FIG. 3 are not stored in computer 10 but rather are stored in one or more computers or electronic storage devices that are addressable by computer 10. As such, any arrangement of the data structures and software modules illustrated in FIG. 3 on one or more computers is within the scope of the disclosure so long as these data structures and software modules are addressable by computer 10 across network/Internet 34 or by other electronic means. Moreover, other systems, application modules and databases not shown in FIG. 3 can be stored in system memory 36. Thus, the present disclosure fully encompasses a broad array of computer systems. Moreover, computer 10 may in fact comprise a plurality of servers that are in electrical communication with each other and that each contains one or more of the software modules and/or data structures illustrated in FIG. 3.

### 5.2 Exemplary Methods

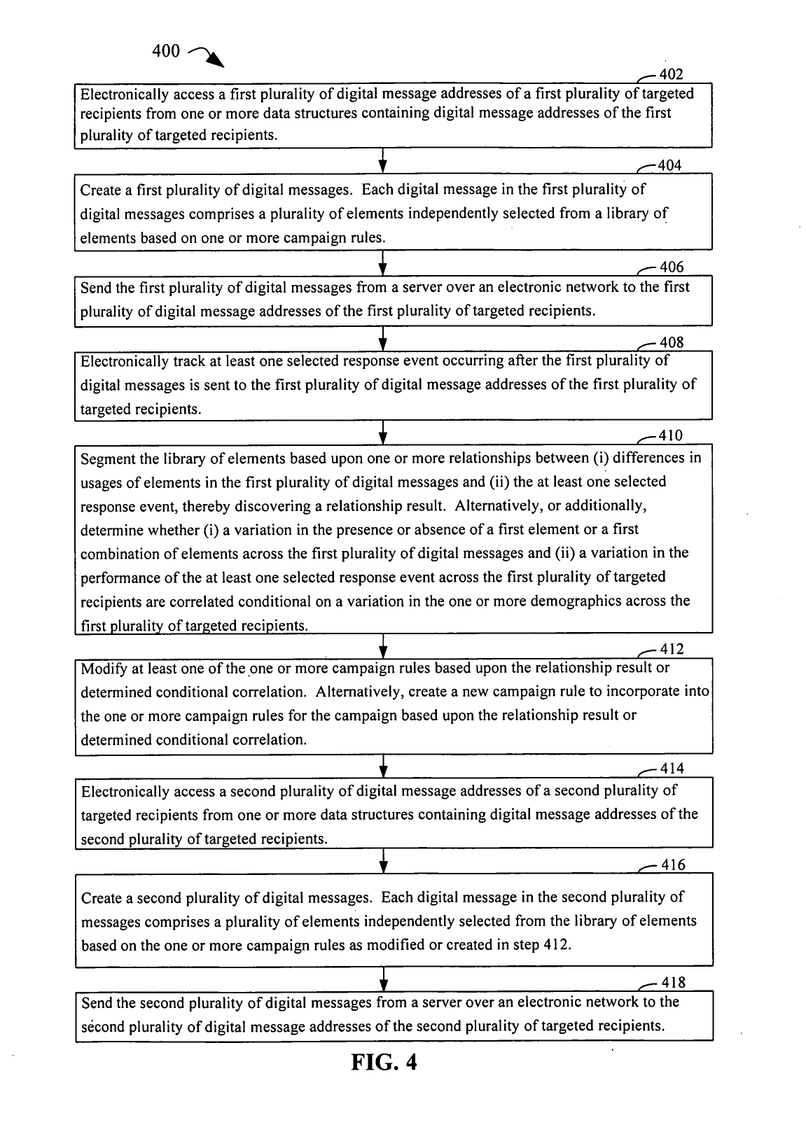

Now that an overview of a system in accordance with one embodiment of the present disclosure has been described, various advantageous methods that can be used in accordance with the present disclosure will now be disclosed in conjunction with FIGS. 3 and 4. In particular, FIG. 4 provides a general overview of a method 400 for optimizing a response of a computer based e-mail marketing campaign using computer based processing. The term “optimizing” is used to describe the attempt to improve performance though those workers having ordinary skill in the art will appreciate that while there may be only a single “optimum” which may not always be attained, there are many degrees of performance improvement that may be obtained. As used in this description, optimization conveniently means improvement rather than requiring attainment of any single optimum value. Put differently, optimization refers to procedures, algorithms, and other attempts to attain optimum performance rather than requiring that the optimum performance be attained.

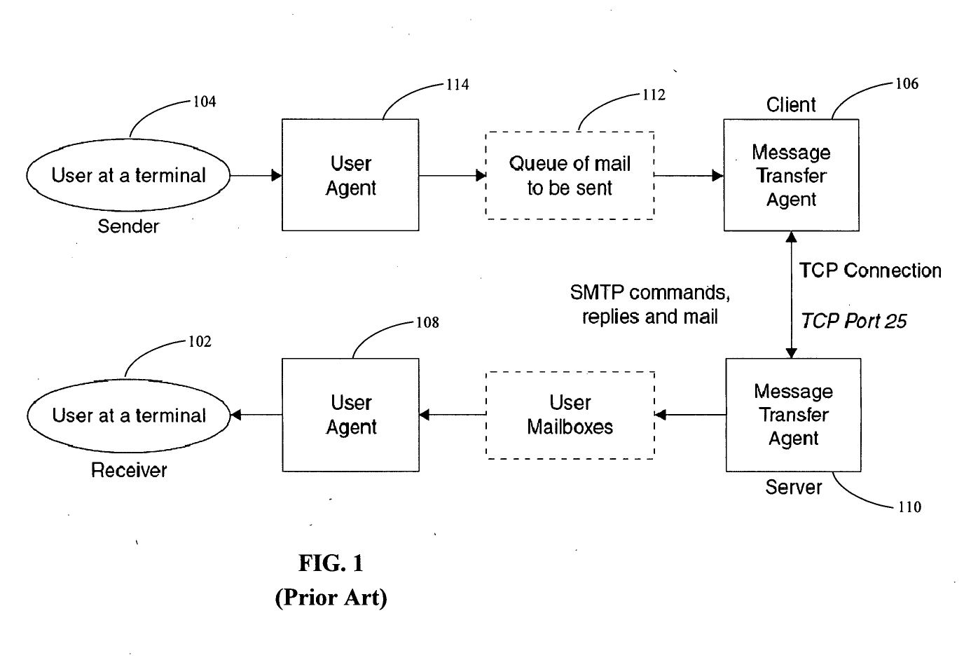

Step 402. In step 402, a first plurality of digital message addresses of a first plurality of targeted recipients are electronically accessed from one or more data structures (e.g., digital message data store 46 of FIG. 1) containing digital message addresses 50 of a first plurality of targeted recipients in a campaign. In some embodiments, the first plurality of digital message addresses comprises one hundred or more digital message addresses, one thousand or more digital message addresses, ten thousand or more e-mail digital message addresses, one hundred thousand or more digital message addresses, five hundred thousand or more digital message addresses, or a million or more digital message addresses. In some embodiments, there is a one to one correspondence between each respective digital message address 50 in the first plurality of digital message addresses and a respective targeted recipient 48. In some embodiments, one or more demographics 52 is known for each targeted recipient 48. Exemplary demographics include, but are not limited to, an age of a targeted recipient, an income of a targeted recipient, a gender of a targeted recipient, a health status of a targeted recipient, a location of a targeted recipient, an internet connection speed used by a targeted recipient, a political association of a targeted recipient, or a marital status of a targeted recipient.

Step 404. In step 404 a first plurality of digital messages is created. In some embodiments, a different digital message is created for each of the first plurality of digital message addresses. In some embodiments, two or more different digital messages are created but some digital messages in the first plurality of digital messages receive the same digital message. In some embodiments, three or more, four or more, five or more, six or more, ten or more, twenty or more, one hundred or more, two hundred or more, five hundred or more, one thousand or more, ten thousand or more, one hundred thousand or more, or one million or more digital messages are created. Each digital message in the first plurality of digital messages comprises a plurality of elements 62 independently selected from a library of elements 90 based on one or more campaign rules 58.

Examples of elements that can be included in a digital message in step 404 include, but are not limited to, a predetermined subject line, a text message, a graphic, a clickable hyperlink, a position of a text message in a digital message, a position of a graphic in a digital message, a position of a clickable hyperlink, a background color of a digital message, a font used in a digital message, a point size for text in a digital message, a video clip, a position of a video clip in a digital message, a quality of a video clip in a digital message, or a compression format of a video clip in a digital message.

In some embodiments, a campaign rule in the one or more campaign rules specifies an allowed percentage range for incorporation of an element or a combination of elements in the library of elements into a plurality of digital messages. For example, consider the case where the element is the use of a subject line that states “Sale starts Thursday” and the campaign rule states that this element may be used between 10 and 30 percent of the time in a plurality of digital messages. Accordingly, when the plurality of digital messages is created in step 404, between 10 and 30 percent of the digital messages will have the subject line “Sale starts Thursday.”

In some embodiments, a campaign rule in the one or more campaign rules specifies an allowed percentage of time for incorporation of an element or a combination of elements in the library of elements into a plurality of digital messages. For example, consider the case where the element is again the use of a subject line that states “Sale starts Thursday” and the campaign rule states that this element may be used 30 percent of the time in a plurality of digital messages. Accordingly, when the plurality of digital messages is created in step 404, exactly 30 percent of the digital messages will have the subject line “Sale starts Thursday.”

In some embodiments, specification of a range of allowed usage of an element is advantageous in order to accommodate other additional campaign rules. For example, the campaign may have a first campaign rule that specifies an allowed percentage range for a first element and a second campaign rule that specifies an allowed percentage range for a combination of elements that includes the first elements. By having allowed ranges, it is possible to accommodate both rules. In more complex examples, additional logic can be built into campaign rules. For example, one campaign rule may state to incorporate a given element into digital messages if another campaign rule is present, but to not incorporate a given element into digital messages of another campaign rule is not present. Moreover, in some embodiments, conditional logic can be built into the campaign rules. For example, a campaign rule may specify to incorporate an element or combination of elements into a plurality of digital messages with a first probability range if the day of week is Saturday, and to incorporate an element or combination of elements into a plurality of digital messages with a second probability range if the day of week is any other day but Saturday.

In some embodiments, a campaign rule in the one or more campaign rules specifies a probability that an element or a combination of elements in the library of elements is to be incorporated into a digital message in a plurality of digital messages. In some embodiments, a campaign rule in the one or more campaign rules specifies an allowed number of times or an allowed range of times an element or a combination of elements in the library of elements can be incorporated into a plurality of digital messages.

In some embodiments, a campaign has two or more campaign rules, three or more campaign rules, five or more campaign rules, or ten or more campaign rules. In some embodiments, a campaign rule operates on a combination of elements. In some embodiments, the combination of elements is two or more elements, three or more elements, five or more elements, ten or more elements, or one hundred or more elements.

Step 406. In step 406, the first plurality of digital messages is sent from a server over an electronic network to the first plurality of digital message addresses of the first plurality of targeted recipients. In some embodiments, each digital message includes text, markup language (e.g., HTML, WML, BHTML, RDF/XML, RSS, MathML, XHTML, SVG, cXML or XML), or other scripts or objects. In some embodiments, some of the text or other scripts or objects are elements whose absence or presence in any given digital message is regulated by the one or more campaign rules and some of the text or other scripts or objects are elements are not regulated by the one or more campaign rules. Thus, each digital message may have “constant” elements (text, scripts, objects, video, etc.) that appear in each respective digital message in the plurality of digital messages and “variable” elements that only appear in some of the digital messages, where the absence or presence of the “variable” elements is regulated by the one or more campaign rules.

Step 408. In step 408, at least one selected response event, occurring after the first plurality of digital messages is sent to the first plurality of digital message addresses of the first plurality of targeted recipients, is electronically tracked. Nonlimiting examples of response events include, but are not limited to, a deliverability rate, a digital message open rate, a click through rate, a conversion rate, a purchase rate, a reply rate, and an unsubscribe rate. Of interest is the performance of the at least one selected response event. For example, in the case where the at least one selected response event is a deliverability rate, what is of interest is the percentage of the first plurality of digital messages that are successfully delivered to the targeted recipients. In the case where the at least one selected response event is a digital message open rate, what is of interest is the percentage of the first plurality of digital message mails that were opened (e.g., read) by the targeted recipients. In the case where the at least one selected response event is a click through rate, what is of interest is the percentage of the first plurality of digital messages in which the targeted recipients clicked on a challenge presented by the digital message (e.g., accepted a user agreement challenge), and so forth. In preferred embodiments, what is tracked is not only an overall performance of the selected response event among the first plurality of digital messages but, also, which specific digital messages in the first plurality of digital messages had a successful response event and which digital messages in the first plurality of digital messages did not have a successful response event. More specifically, in preferred embodiments, what is tracked is which digital messages sent to which targeted recipients had a successful response event and which digital messages sent to which targeted recipients did not have a successful response event.

Step 410. In step 410, the data collected in step 408 is analyzed in order to improve upon the one or more campaign rules for the campaign. As disclosed in more detail below, the improved campaign rules are then used to generate a second plurality of digital messages that are sent to a second plurality of targeted recipients with the goal being that the performance of the at least one selected response event will improve with the second plurality of digital messages because of the refinement or optimization of the one or more campaign rules.

In step 410, the first plurality of digital messages is treated as a learning set from which relationships or conditional correlations are discovered. These relationships or conditional correlations are then used to improve the campaign rules for the campaign or to create new campaign rules for the campaign.

In one aspect, the library of elements is segmented based upon one or more relationships between (i) differences in usages of elements in the first plurality of digital messages and (ii) the at least one selected response event, thereby discovering a relationship result.

In some embodiments, the relationship result is a correlation between (i) the usage of a first element in the first plurality of digital messages and (ii) performance in the selected response event. For example, consider the case where a first element is present in some of the e-mails in the first plurality of digital messages and is not used on others of the digital messages in the first plurality of digital messages. Consider further that the pattern of presence/absence of the first element across the first plurality correlates well with the performance of the selected response element. For instance, those digital messages that have the first element have significantly higher (e.g., favorable) performance in the selected response event than those digital messages that do not have the first element. In this instance, the discovery of the correlation between the presence/absence of the element in the digital message and performance in the selected response event establishes that those digital messages in the first plurality of digital messages that incorporate the first element exhibit an overall improvement in the selected response event relative to those digital messages in the first plurality of digital messages that do not incorporate the first element.

When such a correlation described in the preceding paragraph is discovered, a campaign rule in the one or more campaign rules is modified in step 412 so that the campaign rule specifies a new frequency of incorporation of the first element in a plurality of digital messages. This new frequency is higher than an original frequency of incorporation of the first element in a plurality of digital messages specified by the campaign rule. As a consequence, the first element will be present in a higher percentage of the second plurality of digital messages than it was in the first plurality of digital messages. Alternatively, a new campaign rule can be added to the one or more campaign rules for the computer based marketing campaign when such a correlation described in the preceding paragraph is discovered, where the new campaign rule specifies a frequency of incorporation of the first element in a plurality of digital messages.

In some embodiments, the presence of an element in the first plurality of digital messages is correlated with a deterioration in the performance of a selected response event, rather than an improvement in the performance of the selected response event. Thus, in some embodiments, the relationship result that is discovered in step 410 is a correlation between (i) the usage of a first element in the first plurality of digital messages and (ii) performance in the selected response event, where the correlation establishes that those digital messages in the first plurality of digital messages that incorporate the first element exhibit an overall deterioration in the selected response event relative to those digital messages in the first plurality of digital messages that do not incorporate the first element. In some embodiments, when such a relationship is discovered in step 410, a campaign rule in the one or more campaign rules is modified so that the campaign rule specifies a new frequency of incorporation of the first element in a plurality of digital messages, where the new frequency is lower than an original frequency of incorporation of the first element in a plurality of digital messages specified by the campaign rule before modification, thereby causing the first element to be present in a lower percentage of a second plurality of digital messages than it was in the first plurality of digital messages. In some embodiments, when such a relationship is discovered in step 410, the modifying step 412 comprises adding a new campaign rule to the one or more campaign rules for the computer based marketing campaign, where the new campaign rule specifies a frequency of incorporation of the first element in a plurality of digital messages.

In some embodiments the relationship result discovered in step 410 is a correlation between (i) the usage of a first combination of elements in the first plurality of digital messages and (ii) performance in the selected response event. For example, the combination of elements can be a particular subject line “Sales begins Thursday” and a particular text message in the body of the digital messages. In some embodiments, the combination of elements is two or more elements, three or more elements, four or more elements, for five or more elements. In some embodiments the correlation establishes that those digital messages in the first plurality of digital messages that incorporate the first combination of elements exhibit an overall improvement in the selected response event relative to those digital messages in the first plurality of e-mails that do not incorporate the first combination of elements.

In some embodiments, when the correlation in the preceding paragraph is discovered, the modifying step 412 comprises modifying a campaign rule in the one or more campaign rules so that the campaign rule specifies a new frequency of incorporation of the first combination of elements in a plurality of digital messages, where the new frequency is higher than an original frequency of incorporation of the first combination of elements in a plurality of digital messages specified by the campaign rule before the modifying step 412 was fired (run), thereby causing the first combination of elements to be present in a higher percentage of the second plurality of digital messages than in the first plurality of digital messages. Alternatively, in some embodiments where the correlation in the preceding paragraph is discovered, the modifying step 412 comprises adding a new campaign rule to the one or more campaign rules for the computer based marketing campaign, where the new campaign rule specifies a frequency of incorporation of the first combination of elements in a plurality of digital messages.

In some embodiments, the relationship result that is discovered in step 410 is a correlation between (i) the usage of a first combination of elements in the first plurality of digital messages and (ii) performance in the selected response event, where the correlation establishes that those digital messages in the first plurality of digital messages that incorporate the first combination of elements exhibit an overall deterioration in the selected response event relative to those digital messages in the first plurality of digital messages that do not incorporate the first combination of elements.

In some embodiments, where the correlation in the preceding paragraph is discovered, the modifying step 412 comprises modifying a campaign rule in the one or more campaign rules so that the campaign rule specifies a new frequency of incorporation of the first combination of elements in a plurality of digital messages, where the new frequency is lower than an original frequency of incorporation of the first combination of elements in a plurality of digital messages specified by the campaign rule before the modifying, thereby causing the first combination of elements to be present in a lower percentage of the second plurality of digital messages than it was in the first plurality of digital messages. Alternatively, in some embodiments where the correlation in the preceding paragraph is discovered, the modifying step 412 comprises adding a new campaign rule to the one or more campaign rules for the computer based marketing campaign, where the new campaign rule specifies a frequency of incorporation of the first combination of elements in a plurality of digital messages.

Methods for discovering correlations between elements in the first plurality of digital messages and performance of at least one selected response event have been discussed above. Such correlations can be discovered using pattern classification techniques and/or regression. Exemplary pattern classification techniques that may be used in step 410 include, but are not limited to, Bayesian analysis, regression, and clustering. Additional exemplary pattern classification techniques that may be used in the step 410 include, but are not limited to Bayesian analysis, a Parzen window, kₙ-Nearest-neighbor estimation, fuzzy classification, a linear discriminant function, a Ho-Kashyap procedure, a support vector machine, a neural network, simulated annealing, deterministic simulated annealing, a genetic algorithms, a decision trees, a classification and regression tree (CAR), a mixture-of-expert model, a chi-square test, a student's t-test, regression, a linear regression, a Kernel method, an additive trees, or a Markov network. See, for example, Duda, Pattern Classification, Second Edition, 2001, John Wiley & Sons, Inc., which is hereby incorporated by reference herein in its entirety for its teaching of pattern classification techniques that can be used to discover one or more relationships between (i) differences in usages of elements in the first plurality of digital messages and (ii) at least one selected response event. See also, for example, Hastie et al., 2001, The Elements of Statistical Learning, Springer-Verlag, New York, Chapter 9, which is hereby incorporated by reference herein in its entirety for its teaching of pattern classification techniques and/or regression techniques that can be used to discover one or more relationships between (i) differences in usages of elements in the first plurality of digital messages and (ii) at least one selected response event. Further, any of the methods disclosed in Section 5.3 can be used to discover one or more relationships between (i) differences in usages of elements in the first plurality of digital messages and (ii) at least one selected response event.

In general, the multiple regression equation of interest can be written

Y=α+β₁X₁+β₂X₂+ . . . +βₖXₖ+ε

where Y, the dependent variable, is the performance of at least one selected response event across the first plurality of digital messages and each Xₖ is an element or demographic. This model says that the dependent variable Y depends on k explanatory variables, plus an error term that encompasses various unspecified omitted factors. In the above-identified model, the parameter β₁ gauges the effect of the first explanatory variable X₁ on the dependent variable Y, holding the other explanatory variables constant. Similarly, β₂ gives the effect of the explanatory variable X₂ on Y, holding the remaining explanatory variables constant.

In general, in the multiple regression procedure, estimates for, βᵢ are obtained by taking into account how uncontrolled changes in other variables influence Y. Thus, in specific embodiments of the present invention, regression is used to eliminate at least some of the elements or demographics because the regression takes into account patterns in which multiple elements and/or demographics influence the dependent variable (performance of the at least one selected response event) in a concerted fashion.

In some embodiments, addition interaction terms are also considered. For instance, in the example above, another regression model that can be computed is

Y=α+β₂X₂+β₃X₃+β₄X₂X₃ε

where the coefficient β₄ represents the interaction between element or demographic X₂ and element or demographic X₃.

In some embodiments, a variation in one or more demographics across the first plurality of targeted recipients is known. For example, referring to FIG. 3, in some embodiments one or more demographics 52 is known for each targeted recipient 48. Exemplary demographics include, but are not limited to, an age of a targeted recipient, an income of a targeted recipient, a gender of a targeted recipient, a health status of a targeted recipient, a location of a targeted recipient, an internet connection speed used by a targeted recipient, a political association of a targeted recipient, or a marital status of a targeted recipient.

In some embodiments, where a variation in one or more demographics across the first plurality of targeted recipients is known the segmenting step comprises determining whether (i) a variation in the presence or absence of a first element across the first plurality of digital messages (E) and (ii) a variation in the performance of the at least one selected response event across the first plurality of targeted recipients (R) are correlated conditional on a variation in the one or more demographics across the first plurality of targeted recipients (D).

More formally, a determination of whether a variation in the performance of the at least one selected response event across the first plurality of targeted recipients T is correlated with a variation in the presence or absence of a first element across the first plurality of digital messages and E, conditional on a variation in the one or more demographics across the first plurality of targeted recipients D can be expressed as:

P(R,E|D)=P(R|D)P(E|D)

This property is satisfied only if R and E are conditionally dependent upon D. For formal theoretical support for this conditional dependence property, see Pearl, 1988, Probabilistic Reasoning In Intelligent Systems: Networks of Plausible Inference, Revised Second Printing, Morgan Kaufmann Publishers, Inc., San Francisco, Calif., Section 3.1.2, which is hereby incorporated by reference. This conditional dependency property is related to the mutual information measure that is typically used in network reconstruction problems:

$$I ( R , E \vert D ) = {\sum }_{R , E , D} P ( R , E , D ) log ( \frac{P ( R , E \vert D )}{P ( R \vert D ) P ( E \vert D )} )$$

The use of mutual information is the reduction in uncertainty about one variable due to the knowledge of the other variable. See, for example, Duda et al., 2001, Pattern Classification, John Wiley & Sons, Inc., New York, p 632, which is hereby incorporated by reference herein in its entirety.

In some embodiments, (i) a variation in the presence or absence of a first element or a first combination of elements across the first plurality of digital messages (E) and (ii) a variation in the performance of the at least one selected response event across the first plurality of targeted recipients (R) are correlated conditional on a variation in the one or more demographics across the first plurality of targeted recipients (D) when E, given D, explains at least thirty percent, at least forty percent, at least fifty percent, at least sixty percent, at least seventy percent, at least eighty percent, or at least ninety percent of the variation in R. In some embodiments, when the segmenting described above identified the conditional correlation, the modifying step 412 modifies a campaign rule in the one or more campaign rules so that the campaign rule specifies a new frequency of incorporation of the first element or the first combination of elements in those e-mails in a plurality of digital messages that are targeted to recipients that have the one or more demographics, where the new frequency is higher or lower than an original frequency of incorporation of the first element or the first combination of elements in those digital messages in a plurality of digital messages that are targeted to recipients that have the one or more demographics specified by the campaign rule before step 412 was run, thereby causing the first element or the first combination of elements to be present in a higher or lower percentage of the digital messages in a second plurality of digital messages that are targeted to recipients that have the one or more demographics than in the digital messages in the first plurality of digital messages that are targeted to recipients that have the one or more demographics. In some embodiments, when the segmenting described above determines that (i) a variation in the presence or absence of a first element or a first combination of elements across the first plurality of digital messages (E) and (ii) a variation in the performance of the at least one selected response event across the first plurality of targeted recipients (R) are correlated conditional on a variation in the one or more demographics across the first plurality of targeted recipients (D) when E given D explains at least thirty percent, at least forty percent, at least fifty percent, at least sixty percent, at least seventy percent, at least eighty percent, or at least ninety percent of R.

In some embodiments, a variation in one or more demographics across the first plurality of targeted recipients is known, and the segmenting step 410 comprises determining whether (i) a variation in the presence or absence of a first element or a first combination of elements across the first plurality of digital messages (E) and (ii) a variation in the performance of the at least one selected response event across the first plurality of targeted recipients (R) are correlated conditional on a variation in the one or more demographics across the first plurality of targeted recipients (D). In such embodiments, when the segmenting step 410 determines that such a conditional correlation exists, the modifying step 412 comprises creating a campaign rule to be added to the one or more campaign rules for the campaign, where the campaign rule specifies a frequency of incorporation of the first element or the first combination of elements in those digital messages in a plurality of digital messages that are targeted to recipients that have the one or more demographics. In some embodiments, (i) a variation in the presence or absence of the first element or the first combination of elements across the first plurality of digital messages (E) and (ii) a variation in the performance of the at least one selected response event across the first plurality of targeted recipients (R) are correlated conditional on a variation in the one or more demographics across the first plurality of targeted recipients (D) when E given D explains at least thirty percent, at least forty percent, at least fifty percent, at least sixty percent, at least seventy percent, at least eighty percent, or at least ninety percent of R.

In some embodiments, the one or more demographics is an age of a targeted recipient, an income of a targeted recipient, a sex of a targeted recipient, a health status of a targeted recipient, a location of a targeted recipient, an internet connection speed used by a targeted recipient, a political association of a targeted recipient, and/or a marital status of a targeted recipient.

In some embodiments, the discovery of (i) a variation in the presence or absence of a first element or a first combination of elements across the first plurality of digital messages (E) and (ii) a variation in the performance of the at least one selected response event across the first plurality of targeted recipients (R) being correlated conditional on a variation in the one or more demographics across the first plurality of targeted recipients (D) is made by a pattern classification technique. In some embodiments, this conditional correlation is determined using Bayesian analysis, regression, or clustering. In some embodiments, this conditional correlation is determined using Bayesian analysis, a Parzen window, kₙ-Nearest-neighbor estimation, fuzzy classification, a linear discriminant function, a Ho-Kashyap procedure, a support vector machine, a neural network, simulated annealing, deterministic simulated annealing, a genetic algorithms, a decision trees, a classification and regression tree (CAR), a mixture-of-expert model, a chi-square test, a student's t-test, regression, a linear regression, a Kernel method, an additive trees, or a Markov network. See, for example, Duda, Pattern Classification, Second Edition, 2001, John Wiley & Sons, Inc., which is hereby incorporated by reference herein in its entirety for its teaching of pattern classification techniques that can be used to discover conditional correlation. See also, for example, Hastie et al., 2001, The Elements of Statistical Learning, Springer-Verlag, New York, Chapter 9, which is hereby incorporated by reference herein in its entirety for its teaching of pattern classification techniques and/or regression techniques that can be used to discover conditional correlation. Further, any of the methods disclosed in Section 5.3 can be used to discover the disclosed conditional correlation.

In some embodiments, in addition to discovering relationships between presence/absence of elements and one or more response events across the first plurality of digital messages and/or first plurality of targeted recipients, there is also processes for discovering elements or demographics that do not affect the variation in the performance of the one or more response events across the first plurality of digital messages and/or first plurality of targeted recipients. In some embodiments, therefore, one or more elements in the library of elements that do not affect the variation in the performance of the at least one selected response event across the first plurality of targeted recipients are eliminating from consideration. In one embodiment, this is performed by backward stepwise regression.

In specific embodiments, all or a portion of the elements used in any of the first plurality of digital messages are fit to the variance in the performance of the one or more selected response events across the first plurality of digital messages/targeted recipients using regression. Then, in a stepwise fashion, some of the molecular markers are eliminated from the model using backward stepwise regression. Backward stepwise regression begins with a full or saturated model and variables are eliminated from the model in an iterative process. The fit of the model is tested after the elimination of each variable (element) to ensure that the model still adequately fits the data. When no more elements can be eliminated from the model or a desired number of elements remain in the model, the analysis has been completed. In specific embodiments, this process is used to reduce the number of elements that are considered to less than 25, less than 20, less than 15, less than 10, less than 5, or less than 3 elements. In some embodiments, absence or presence of one or more demographics associated with one or more of the targeted recipients are also considered as independent variables along with elements in a backward stepwise regression where performance of the selected one or more responses event is the dependent variable. In this way, demographics that do not influence the performance of the selected one or more responses are eliminated from consideration.

In one embodiment, a regression model is computed using all or a portion of the elements in the library of elements and the one or more demographics as independent variables. Then, coefficients are tested for significance for inclusion or elimination from the model using a Wald test, a likelihood-ratio test (chi-squared statistic), a Hosmer-Lemshow Goodness of Fit Test, or the like. For example, the likelihood-ratio test uses the ratio of the maximized value of the likelihood function for the full model (L₁) over the maximized value of the likelihood function for the simpler model (L₀) in which one or more elements and/or demographics have been removed. The likelihood-ratio test statistic equals:

$$- 2 log ( \frac{{L}_{0}}{{L}_{1}} )$$

This log transformation of the likelihood functions yields a chi-squared statistic.

In some embodiments, step 410 comprises segmenting the library of elements based upon one or more relationships between (i) differences in one or more demographics in the first plurality of digital messages and (ii) the at least one selected response event, thereby discovering a relationship result.

Step 412. In step 412, at least one of the one or more campaign rules is modified based upon the relationship result or determined conditional correlation discovered in step 410. Alternatively, a new campaign rule is created to incorporate into the one or more campaign rules for the campaign based upon the relationship result or determined conditional correlation discovered in step 410. Alternatively still, a campaign rule is removed from the one or more campaign rules for the campaign based upon the relationship result or determined conditional correlation discovered in step 410.

To illustrate, consider a campaign rule in the one or more campaign rules that specifies an allowed percentage of time for incorporation of an element 62 or a combination of elements in the library of elements 90 into a plurality of digital messages. For example, consider the case where the element 62 is the use of a subject line that states “Sale starts Thursday” and the campaign rule states that this element may be used between 30 and 40 percent of the time in a plurality of digital messages. Accordingly, when the first plurality of digital messages is created in step 404, between 30 percent and 40 percent of a plurality of digital messages will have the subject line “Sale starts Thursday.” Next, consider the case where that step 410 determines that the inclusion of this subject line is highly correlated with improved performance of at least one selected response event. In this instance, step 412 may modify the campaign rule to state that between 40 percent and 50 percent of a plurality of digital messages will have the subject line “Sale starts Thursday.” Thus, each time another plurality of digital messages is created between 40 percent and 50 percent of a plurality of digital messages will have the subject line “Sale starts Thursday” until the rule is modified or removed from the campaign.

Step 414. In step 414, a second plurality of e-mail addresses of a second plurality of targeted recipients is electronically accessed from one or more data structures containing digital messages addresses of the second plurality of targeted recipients. In some embodiments the digital message addresses are pulled from the same digital message data store 46 that was accessed in step 402. In some embodiments, each of the digital messages addresses in the second plurality of digital message addresses is not found in the first plurality of digital message addresses that was accessed in step 402. In some embodiments, all or some of the digital message addresses in the second plurality of digital message addresses is found in the first plurality of digital message addresses.

In some embodiments, the second plurality of digital message addresses comprises one hundred or more digital message addresses, one thousand or more digital message addresses, ten thousand or more digital message addresses, one hundred thousand or more digital message addresses, five hundred thousand or more digital message addresses, or a million or more digital message addresses. In some embodiments, there is a one to one correspondence between each respective digital message address 50 in the second plurality of digital message addresses and a respective targeted recipient 48. In some embodiments, one or more demographics 52 is known for each targeted recipient 48. Exemplary demographics include, but are not limited to, an age of a targeted recipient, an income of a targeted recipient, a gender of a targeted recipient, a health status of a targeted recipient, a location of a targeted recipient, an internet connection speed used by a targeted recipient, a political association of a targeted recipient, or a marital status of a targeted recipient.

Step 416. In step 416 a second plurality of digital messages is created. Each digital message in the second plurality of digital messages comprises a plurality of elements independently selected from the library of elements based on the one or more campaign rules as modified or created in step 412.

In some embodiments, a different marketing message is created for each of the second plurality of digital message addresses. In some embodiments, two or more different digital messages are created but some digital messages in the second plurality of digital messages receive the same marketing message. In some embodiments, three or more, four or more, five or more, six or more, ten or more, twenty or more, one hundred or more, two hundred or more, five hundred or more, one thousand or more, ten thousand or more, one hundred thousand or more, or one million or more digital messages are created in step 416. Each marketing message in the second plurality of digital messages comprises a plurality of elements 62 independently selected from a library of elements 90 based on one or more campaign rules 58 as modified or created in the last instance of step 412.

Step 418. In step 418 the second plurality of digital messages is sent from a server over an electronic network to the second plurality of digital message addresses of the second plurality of targeted recipients.

In some embodiments, certain of the steps in FIG. 4 are repeated. For example, in some embodiments, steps 400 through 412 are repeated. In some such embodiments, each time step 402 is repeated, a different first plurality of digital message addresses is electronically accessed for a different first plurality of targeted recipients. Further, each time step 404 is repeated, a different first plurality of marketing messages is created based on the most recent modification of the campaign rules in step 412. By repeating the steps in this way, a campaign can be broken down into several stages, where the digital messages for each stage are created based on modified or new campaign rules. In such embodiments, step 410 can discover relationships or conditional correlations by pooling together all prior pluralities of digital messages that have already been sent out in the campaign. Alternatively, in some embodiments, step 410 can discover relationships or conditional correlations based by pooling together just some of the pluralities of digital messages that have already been sent out in the campaign (e.g., the last two pluralities, the last three pluralities, all but the first plurality, all but the first two pluralities, etc.). Alternatively, step 410 can discover relationships or conditional correlations based by only considering the plurality of digital messages that was sent out just prior to running step 410.

### 5.3 Exemplary Pattern Classification Techniques

Decision tree. In one embodiment step 410 discovers one or more relationships using a decision tree. Decision trees are described generally in Duda, 2001, Pattern Classification, John Wiley & Sons, Inc., New York, pp. 395-396, which is hereby incorporated herein by reference. One specific algorithm that can be used is a classification and regression tree (CART). Other specific algorithms for learning the pairwise probability function include, but are not limited to, ID3, C4.5, MART, and Random Forests. CART, ID3, and C4.5, each described in Duda, 2001, Pattern Classification, John Wiley & Sons, Inc., New York, pp. 396-408 and pp. 411-412, which is hereby incorporated by reference herein in its entirety. CART, MART, and C4.5 are also described in Hastie et al., 2001, The Elements of Statistical Learning, Springer-Verlag, New York, Chapter 9, which is hereby incorporated by reference herein in its entirety. The Random Forests technique is described in Breiman, 1999, “Random Forests—Random Features,” Technical Report 567, Statistics Department, University of California at Berkeley, September 1999, which is hereby incorporated by reference herein in its entirety.

In addition to univariate decision trees, a learned pairwise probability function g_{pq}(X, W_{pq}) can be a multivariate decision tree. In such a multivariate decision tree, some or all of the decisions actually comprise a linear combination of elements or demographics. Such a linear combination can be trained to derive the learned pairwise probability function using known techniques such as gradient descent on a classification or by the use of a sum-squared-error criterion. To illustrate such a decision tree, consider the expression:

0.04x₁+0.16x₂<500

Here, x₁ and x₂ refer to two different elements from among the elements in the plurality of elements. To poll the learned pairwise probability function, the values of elements x₁ and x₂ are taken from the plurality of digital messages (e.g., x₁ is “1” if the element is present and “0” if the element is not present in an digital message). These values are then inserted into the equation. If a value of less than 500 is computed, then a first branch in the decision tree is taken. Otherwise, a second branch in the decision tree is taken. Multivariate decision trees are described in Duda, 2001, Pattern Classification, John Wiley & Sons, Inc., New York, pp. 408-409, which is hereby incorporated by reference herein in its entirety.

Multivariate adaptive regression splines. Another approach that can be used in step 410 is multivariate adaptive regression splines (MARS). MARS is an adaptive procedure for regression, and is well suited for the high-dimensional problems addressed by the present invention. MARS can be viewed as a generalization of stepwise linear regression or a modification of the CART method to improve the performance of CART in the regression setting. MARS is described in Hastie et al., 2001, The Elements of Statistical Learning, Springer-Verlag, New York, pp. 283-295, which is hereby incorporated by reference herein in its entirety.

Centroid classifier techniques. In one embodiment step 410 uses a nearest centroid classifier technique. This approach is similar to k-means clustering except clusters are replaced by known classes. This algorithm can be sensitive to noise when a large number of elements and/or demographics are used. See, for example, Tibshirani et al., 2002, Proceedings of the National Academy of Science USA 99; 6567-6572, which is hereby incorporated by reference herein in its entirety.

Bagging, boosting, the random subspace method and additive trees. In some embodiments, the relationships discovered in step 410 can be refined and improved using bagging, boosting, the random subspace method, and additive trees. These techniques are designed for, and usually applied to, decision trees, such as the decision trees described above. In addition, such techniques can also be useful in decision rules developed using other types of data analysis algorithms such as linear discriminant analysis.

In bagging, one samples the first plurality of digital messages, generating random independent bootstrap replicates, constructs the pairwise probability function on each of these, and aggregates them by a simple majority vote in the final learned pairwise probability function. See, for example, Breiman, 1996, Machine Learning 24, 123-140; and Efron & Tibshirani, An Introduction to Boostrap, Chapman & Hall, New York, 1993, which is hereby incorporated by reference herein in its entirety. See also, for example, Freund & Schapire, “Experiments with a new boosting algorithm,” Proceedings 13th International Conference on Machine Learning, 1996, 148-156, which is hereby incorporated by reference herein in its entirety.

In some embodiments, modifications of the boosting methods proposed by Freund and Schapire, 1997, Journal of Computer and System Sciences 55, pp. 119-139, are used. See, for example, Hasti et al., The Elements of Statistical Learning, 2001, Springer, N.Y., Chapter 10, which is hereby incorporated by reference herein in its entirety. For example, in some embodiments, cellular step 410 is performed using a technique such as the nonparametric scoring methods of Park et al., 2002, Pac. Symp. Biocomput. 6, 52-63, which is hereby incorporated by reference herein in its entirety. Element preselection is a form of dimensionality reduction in which the elements in the first plurality of digital messages that discriminate between different performance levels for the at least one selected response event the best are selected for use in the classifier. Then, the LogitBoost procedure introduced by Friedman et al., 2000, Ann Stat 28, 337-407, is used rather than the boosting procedure of Freund and Schapire. In some embodiments, the boosting and other classification methods of Ben-Dor et al., 2000, Journal of Computational Biology 7, 559-583, hereby incorporated by reference herein in its entirety, are used in the present invention. In some embodiments, the boosting and other classification methods of Freund and Schapire, 1997, Journal of Computer and System Sciences 55, 119-139, hereby incorporated by reference herein in its entirety, are used.

In some embodiments, the random subspace method is used. See, for example, Ho, “The Random subspace method for constructing decision forests,” IEEE Trans Pattern Analysis and Machine Intelligence, 1998; 20(8): 832-844, which is hereby incorporated by reference herein in its entirety. In one embodiment step 410 is performed using a multiple additive regression tree (MART). See, for example, Hastie et al., 2001, The Elements of Statistical Learning, Springer-Verlag, New York, Chapter 10, which is hereby incorporated by reference herein in its entirety.

Regression. In some embodiments, step 410 is performed using regression. In such embodiments, a regression classifier is built that includes a coefficient for each of the elements or demographics in the first plurality of digital messages. In such embodiments, the coefficients for the regression classifier (W_{pq}) are computed using, for example, a maximum likelihood approach. In such a computation, the values for the elements or demographics (e.g., “0” is not in an particular digital message or “1” is in a particular digital message) are used.

Neural networks. In some embodiments, step 410 is performed using a neural network. A neural network is a two-stage regression or classification decision rule. A neural network has a layered structure that includes a layer of input units (and the bias) connected by a layer of weights to a layer of output units. For regression, the layer of output units typically includes just one output unit. However, neural networks can handle multiple quantitative responses in a seamless fashion.

In multilayer neural networks, there are input units (input layer), hidden units (hidden layer), and output units (output layer). There is, furthermore, a single bias unit that is connected to each unit other than the input units. Neural networks are described in Duda et al., 2001, Pattern Classification, Second Edition, John Wiley & Sons, Inc., New York; and Hastie et al., 2001, The Elements of Statistical Learning, Springer-Verlag, New York, each of which is hereby incorporated by reference herein in its entirety. Neural networks are also described in Draghici, 2003, Data Analysis Tools for DNA Microarrays, Chapman & Hall/CRC; and Mount, 2001, Bioinformatics: sequence and genome analysis, Cold Spring Harbor Laboratory Press, Cold Spring Harbor, N.Y., each of which is hereby incorporated by reference herein in its entirety. What are disclosed below are some exemplary forms of neural networks.

The basic approach to the use of neural networks is to start with an untrained network, present a training pattern to the input layer, and to pass signals through the net and determine the output at the output layer. These outputs are then compared to the target values; any difference corresponds to an error. This error or criterion function is some scalar function of the weights W_{pq} and is minimized when the network outputs match the desired outputs. Thus, the weights W_{pq} are adjusted to reduce this measure of error. For regression, this error can be sum-of-squared errors. For classification, this error can be either squared error or cross-entropy (deviation). See, e.g., Hastie et al., 2001, The Elements of Statistical Learning, Springer-Verlag, New York, which is hereby incorporated by reference herein in its entirety.

Three commonly used training protocols are stochastic, batch, and on-line. In stochastic training, patterns are chosen randomly from the training set and the network weights W_{pq} are updated for each pattern presentation. Multilayer nonlinear networks trained by gradient descent methods such as stochastic back-propagation perform a maximum-likelihood estimation of the weight values W_{pq} in the classifier defined by the network topology. In batch training, all patterns are presented to the network before learning takes place. Typically, in batch training, several passes are made through the training data. In online training, each pattern is presented once and only once to the net.

In some embodiments, consideration is given to starting values for weights W_{pq}. If the weights W_{pq} are near zero, then the operative part of the sigmoid commonly used in the hidden layer of a neural network (see, e.g., Hastie et al, 2001, The Elements of Statistical Learning, Springer-Verlag, New York, hereby incorporated by reference herein) is roughly linear, and hence the neural network collapses into an approximately linear classifier. In some embodiments, starting values for weights W_{pq} are chosen to be random values near zero. Hence the classifier starts out nearly linear, and becomes nonlinear as the weights increase. Individual units localize to directions and introduce nonlinearities where needed. Use of exact zero weights W_{pq} leads to zero derivatives and perfect symmetry, and the algorithm never moves. Alternatively, starting with large weights W_{pq} often leads to poor solutions.

Since the scaling of inputs determines the effective scaling of weights W_{pq} in the bottom layer, it can have a large effect on the quality of the final solution. Thus, in some embodiments, at the outset, all expression values are standardized to have mean zero and a standard deviation of one. This ensures all inputs are treated equally in the regularization process, and allows one to choose a meaningful range for the random starting weights.

A recurrent problem in the use of three-layer networks is the optimal number of hidden units to use in the network. The number of inputs and outputs of a three-layer network are determined by the problem to be solved. In the present invention, the number of inputs for a given neural network will equal the number of biomarkers selected from Y. The number of output for the neural network will typically be just one. If too many hidden units are used in a neural network, the network will have too many degrees of freedom and if trained too long, there is a danger that the network will overfit the data. If there are too few hidden units, the training set cannot be learned. Generally speaking, however, it is better to have too many hidden units than too few. With too few hidden units, the classifier might not have enough flexibility to capture the nonlinearities in the date; with too many hidden units, the extra weight can be shrunk towards zero if appropriate regularization or pruning, as described below, is used. In typical embodiments, the number of hidden units is somewhere in the range of 5 to 100, with the number increasing with the number of inputs and number of training cases.

Clustering. In some embodiments, step 410 is performed using clustering. Clustering is described on pages 211-256 of Duda and Hart, Pattern Classification and Scene Analysis, 1973, John Wiley & Sons, Inc., New York, (hereinafter “Duda 1973”) which is hereby incorporated by reference in its entirety. As described in Section 6.7 of Duda 1973, the clustering problem is described as one of finding natural groupings in a dataset. To identify natural groupings, two issues are addressed. First, a way to measure similarity (or dissimilarity) between two samples is determined. This metric (similarity measure) is used to ensure that the samples in one cluster are more like one another than they are to samples in other clusters. Second, a mechanism for partitioning the data into clusters using the similarity measure is determined.

Similarity measures are discussed in Section 6.7 of Duda 1973, where it is stated that one way to begin a clustering investigation is to define a distance function and to compute the matrix of distances between all pairs of samples in a dataset. If distance is a good measure of similarity, then the distance between samples in the same cluster will be significantly less than the distance between samples in different clusters. However, as stated on page 215 of Duda 1973, clustering does not require the use of a distance metric. For example, a nonmetric similarity function s(x, x′) can be used to compare two vectors x and x′. Conventionally, s(x, x′) is a symmetric function whose value is large when x and x′ are somehow “similar”. An example of a nonmetric similarity function s(x, x′) is provided on page 216 of Duda 1973.

Once a method for measuring “similarity” or “dissimilarity” between points in a dataset has been selected, clustering requires a criterion function that measures the clustering quality of any partition of the data. Partitions of the data set that extremize the criterion function are used to cluster the data. See page 217 of Duda 1973. Criterion functions are discussed in Section 6.8 of Duda 1973. More recently, Duda et al., Pattern Classification, 2^{nd} edition, John Wiley & Sons, Inc. New York, has been published. Pages 537-563 describe clustering in detail. More information on clustering techniques can be found in Kaufman and Rousseeuw, 1990, Finding Groups in Data: An Introduction to Cluster Analysis, Wiley, New York, N.Y.; Everitt, 1993, Cluster analysis (3d ed.), Wiley, New York, N.Y.; and Backer, 1995, Computer-Assisted Reasoning in Cluster Analysis, Prentice Hall, Upper Saddle River, N.J. Particular exemplary clustering techniques that can be used in the present invention include, but are not limited to, hierarchical clustering (agglomerative clustering using nearest-neighbor algorithm, farthest-neighbor algorithm, the average linkage algorithm, the centroid algorithm, or the sum-of-squares algorithm), k-means clustering, fuzzy k-means clustering algorithm, and Jarvis-Patrick clustering.

Principal component analysis. In some embodiments, step 410 is performed using principal component analysis. Principal component analysis is a classical technique to reduce the dimensionality of a data set by transforming the data to a new set of variable (principal components) that summarize the features of the data. See, for example, Jolliffe, 1986, Principal Component Analysis, Springer, N.Y., which is hereby incorporated by reference herein in its entirety. Principal component analysis is also described in Draghici, 2003, Data Analysis Tools for DNA Microarrays, Chapman & Hall/CRC, which is hereby incorporated by reference herein in its entirety. What follows are non-limiting examples of principal components analysis.

Principal components (PCs) are uncorrelated and are ordered such that the k^{th} PC has the k^{th} largest variance among PCs. The k^{th} PC can be interpreted as the direction that maximizes the variation of the projections of the data points such that it is orthogonal to the first k−1 PCs. The first few PCs capture most of the variation in the data set. In contrast, the last few PCs are often assumed to capture only the residual ‘noise’ in the data.

In one approach to using PCA to learn a pairwise probability function g_{pq}(X, W_{pq}), vectors for the select cellular constituents in Y can be constructed in the same manner described for clustering above. In fact, the set of vectors, where each vector represents the cellular constituent abundance values for the select cellular constituents from a particular member of the training population, can be viewed as a matrix. In some embodiments, this matrix is represented in a Free-Wilson method of qualitative binary description of monomers (Kubinyi, 1990, 3D QSAR in drug design theory methods and applications, Pergamon Press, Oxford, pp 589-638, hereby incorporated by reference herein), and distributed in a maximally compressed space using PCA so that the first principal component (PC) captures the largest amount of variance information possible, the second principal component (PC) captures the second largest amount of all variance information, and so forth until all variance information in the matrix has been considered.

Nearest neighbor analysis. In some embodiments, step 410 uses nearest neighbor analysis. Nearest neighbor classifiers are memory-based and require no classifier to be fit. Given a query point x₀, the k training points x₍ᵣ₎, r, . . . , k closest in distance to x₀ are identified and then the point x₀ is classified using the k nearest neighbors. Ties can be broken at random. In some embodiments, Euclidean distance in feature space is used to determine distance as:

d₍ᵢ₎=∥X₍ᵢ₎−xₒ∥.

The nearest neighbor rule can be refined to deal with issues of unequal class priors, differential misclassification costs, and feature selection. Many of these refinements involve some form of weighted voting for the neighbors. For more information on nearest neighbor analysis, see Duda, Pattern Classification, Second Edition, 2001, John Wiley & Sons, Inc; and Hastie, 2001, The Elements of Statistical Learning, Springer, N.Y., each of which is hereby incorporated by reference herein in its entirety.

Linear discriminant analysis. In some embodiments, step 410 uses linear discriminant analysis. Linear discriminant analysis (LDA) attempts to classify a subject into one of two categories based on certain object properties. In other words, LDA tests whether object attributes measured in an experiment predict categorization of the objects. LDA typically requires continuous independent variables and a dichotomous categorical dependent variable. For more information on linear discriminant analysis, see Duda, Pattern Classification, Second Edition, 2001, John Wiley & Sons, Inc; and Hastie, 2001, The Elements of Statistical Learning, Springer, N.Y.; and Venables & Ripley, 1997, Modern Applied Statistics with s-plus, Springer, N.Y., each of which is hereby incorporated by reference herein in its entirety.

Quadratic discriminant analysis. In some embodiments, step 410 uses linear discriminant analysis. Quadratic discriminant analysis (QDA) takes the same input parameters and returns the same results as LDA. QDA uses quadratic equations, rather than linear equations, to produce results. LDA and QDA are interchangeable, and which to use is a matter of preference and/or availability of software to support the analysis. Logistic regression takes the same input parameters and returns the same results as LDA and QDA.

Support vector machine. In some embodiments, step 410 uses a support vector machine. SVMs are described, for example, in Cristianini and Shawe-Taylor, 2000, An Introduction to Support Vector Machines, Cambridge University Press, Cambridge; Boser et al., 1992, “A training algorithm for optimal margin classifiers,” in Proceedings of the 5^{th} Annual ACM Workshop on Computational Learning Theory, ACM Press, Pittsburgh, Pa., pp. 142-152; Vapnik, 1998, Statistical Learning Theory, Wiley, New York; Mount, 2001, Bioinformatics: sequence and genome analysis, Cold Spring Harbor Laboratory Press, Cold Spring Harbor, N.Y., Duda, Pattern Classification, Second Edition, 2001, John Wiley & Sons, Inc.; and Hastie, 2001, The Elements of Statistical Learning, Springer, N.Y.; and Furey et al., 2000, Bioinformatics 16, 906-914, each of which is hereby incorporated by reference herein in its entirety. When used for classification, SVMs separate a given set of binary labeled data training data with a hyper-plane that is maximally distant from them. For cases in which no linear separation is possible, SVMs can work in combination with the technique of ‘kernels’, which automatically realizes a non-linear mapping to a feature space. The hyper-plane found by the SVM in feature space corresponds to a non-linear decision boundary in the input space. For more information on support vector machines see, for example, Furey et al., 2000, Bioinformatics 16, page 906-914, which is hereby incorporated by reference herein.

Evolutionary methods. In some embodiments, step 410 uses evolutionary methods. More information on evolutionary methods is found in, for example, Duda, Pattern Classification, Second Edition, 2001, John Wiley & Sons, Inc., which is hereby incorporated by reference herein in its entirety.

Projection pursuit, weighted voting. The data analysis algorithms described above are merely examples of the types of methods that can be used in step 410. Moreover, combinations of the techniques described above can be used. Some combinations, such as the use of the combination of decision trees and boosting, have been described. However, many other combinations are possible. In addition, in other techniques in the art such as Projection Pursuit or Weighted Voting can be used to learn the pairwise probability function g_{pq}(X, W_{pq}).

Other methods. In some embodiments, step 410 uses k-nearest neighbors (k-NN), an artificial neural network (ANN), a parametric linear equation, a parametric quadratic equation, a naive Bayes analysis, linear discriminant analysis, a decision tree, or a radial basis function.

### 5.4 Alternative Embodiments

In the embodiments described above, examples were given in which elements and demographics are dichotomous categorical variables (e.g., “0” is not present or associated with an digital message and “1” if present or associated with an digital message). However, the invention is not so limited. In some embodiments each element and/or each demographic may be a continuous variable having any of a range of values. For example, an element may have a value that ranges between a lower value and a higher value based on how many times the element is inserted into a particular digital message. In another example, an element may have a value that ranges between a lower value and a higher value based on how the position of the element within the digital message or the point size used to draw the element. In another example, an element may have a value that ranges between a lower value and a higher value based on how frequently the element flashes in the digital message, etc.

In some embodiments, the one or more modified rules of step 412 are used to modify one or more digital messages in the first plurality of digital messages that have already been sent to targeted recipients. This is possible, for example, in instances where such digital messages contains URLs. By changing the target web pages that these URLs identify, it is possible to modify the user experience with such digital messages based upon the modifications to the one or more campaign rules.

In some embodiments, the method illustrated in FIG. 4 is amended to provide for target population discovery and/or validation based on an evaluation of user activity. For example, consider the case in which a population of targeted recipients is selected and targeted with offers for Spring styles from a predetermined retailer. The campaign is delivered, in the form of digital messages, to a portion (e.g., ten percent) of the population. The performance of a response event is measured among this portion of the population upon or after delivery of the digital messages. These steps are as set forth in steps 402 through 408 of FIG. 4 and in the description of steps 402 through 408 of FIG. 4 in the specification above.

Then, relationship results are discovered. For example, based on the performance of the response event (e.g., clicks, purchases, downloads, etc.), the following exemplary relationships can be discovered using the disclosed methods:
(1) digital messages with a bright yellow background are more popular (are associated with better performance of a response event) than digital messages with a bright red background,
(2) zip code 94065 has more activity than zip code 94061, and
(3) zip code 94065 peak activities are during day time while zip code 94061 peak activities are in the evening.

Relationship discovery (1) is identified, for example, by correlating variance in the background color of the digital message with variance in performance of the response event across the first portion of the population. This can be done using any of the methods disclosed above for FIG. 410 of FIG. 4.

Relationship discovery (2) is identified, for example, by segregating the first portion of the population based on zip code and comparing the performance of the response event by members of the first population from each zip code using, for example, comparison of mean or median values for performance of the response event for members each zip code, a paired t-test, an unpaired t-test, one-way ANOVA, repeated measured ANOVA, one-sample t-test, remated measures ANOVA, a Wilcoxon test, a Mann-Whitney test, a Kiruskal-Wallis test, or a Friedman test, to name a few tests in which the performance of the response event among members from two different zip codes is compared to see if the difference in this performance is statistically significant.

Relationship (3) is discovered, for example, by segregating the first portion of the population based on zip code as well as by a particular time range when the digital message was sent to the target recipients in the first portion (e.g., night, day, afternoon), and comparing the performance of the response event of each such segregated group (e.g., zip code 1 during day, zip code 1 during night, zip code 2 during day, zip code 2 during night, etc.) again using a t-test or some other form of analysis described above for the discovery of relationship discovery (2).

Thus, in these disclosed relationship discovery embodiments, relationship results are discovered using methods disclosed above in conjunction with step 410 of FIG. 4 or by the comparison of performance of subgroups of the first portion of the population as disclosed here.

In an exemplary response to discovery relationship (1), any of the techniques disclosed above in conjunction with step 412 of FIG. 4 may be used. For example, in one embodiment, digital messages that are sent to remaining portions of the target population will be up-weighted for a bright yellow background, meaning that a higher percentage of the digital messages sent to the remaining portions of the population will have a yellow background relative to the percentage of digital messages having a yellow background sent to the first portion of the population.

In an exemplary response to the discovery of relationship (2) any of the techniques disclosed above in conjunction with step 412 of FIG. 4 may be used. Moreover, in some embodiments, a certain recipients may be targeted as a new attribute. For example, those targeted recipients having the demographic “zip code 94065” (meaning that the targeted recipients live in the 94065 zip code) can be tagged with a new attribute, “highly active”. This attribute is reusable in new campaigns or for the remainder of the existing campaign. For example, it might be later on correlated with other attributes, for example, age. In fact, the correlation between the new attribute, “highly active”, and age can be found by reexamination of the first portion of the campaign. For example, with the discovery of the importance of the 94065 zip code, a correlation between this zip code and the age of those targeted recipients in the 94065 zip code can be made. This correlation can be made in several different ways. In one approach, the profiles (demographics) of those targeted recipients in the first portion of the population that are in the 94065 zip code are queried to determine their age. In another approach, a determination can be made to see whether the correlation between the 94065 zip code and the performance of the selected response event is correlated conditional upon recipient age. If, for example, the correlation between the 94065 zip code and the performance of the response event improves when recipient age is factored in, then a correlation between the 94065 zip code and age can be presumed. Alternatively, the correlation between the new attribute, “highly active”, and age can be found by examination of the performance of the response event of another portion of the population. These correlations, once found, can be coded into new or existing campaign rules using any of the methods disclosed in conjunction with step 412 of FIG. 4 above.

The disclosed techniques can also be used for the verification of a suitable target population for a campaign. For example, one embodiment provides a method in which there is (i) the discovery of new attributes based on user behavior (e.g. that a particular zip code is correlated with positive performance of a response event). This discovery can be obtained using the methods disclosed in conjunction with steps 402 through 408 of FIG. 4 as well as the discovery techniques disclosed in this section. Next, in the methods, a subsequent discovery of a correlation of the new attribute to existing attributes (e.g. correlation of this zip code to age) is made. Next, the correlation between the new attribute and known attributes is used to verify a suitable target population based on their user behavior. For example, consider the case where assessment of a first portion of a target population reveals that the 18 to 25 age group is highly correlated with performance of a response event (e.g., purchasing articles). For instance, those in the 18 to 25 age group are very likely to respond to a digital message in a campaign. Then, an evaluation of the 18 to 25 age group determines there is a correlation between this age group and purchasing the ECKO label. This information can be used to verify a new target or a new target population. The new target population asserts that they are in the 18 to 25 age group. However, evaluation of the target population reveals that they are not purchasing the ECKO label. From this, it can be concluded that the members of the new target population are not in the 18 to 25 age group. Of course, the converse may be true, where the new target population asserts that they are in the 18 to 25 age group and evaluation of the target population reveals that they are purchasing the ECKO label thus confirming the age group of the target population. The new confirmed target group may drive subsequent instance of step 404 in a modified version of the method of FIG. 4 in which steps 402 through 418 are performed and where steps 402 through 412 are repeated after step 410, as expanded in this section, discovers new relationships.

Regarding relationship (3) above, knowing that the 94065 zip code is more active during the day time, digital messages may be targeted to this zip code in the day time. Knowing that the zip code 94061 is more active in the evening, digital messages may be targeted to this zip code in the day time. In another example, the demographic, rather than being a zip code, can be any combination of an income of a targeted recipient, a gender of a targeted recipient, a health status of a targeted recipient, a location (e.g., state, city, town, street, etc.) of a targeted recipient (in addition or instead of the zip code example already provided), an internet connection speed used by a targeted recipient, a political association of a targeted recipient, a marital status of a targeted recipient, or a connection type (e.g., SMS, MMS, EMS, e-mail, IMS, EIM, etc.) used by the targeted recipient to receive digital messages, to name a few.

Thus, this section teaches that steps 402 through 412 may be performed, with step 410 expanded as disclosed in this section, to discover or verify target populations. Steps 402 through 412 may be repeated with the second instance of step 402 pulling a plurality of recipients based on the discovered or verified population of the last instance step 410, as expanded in this section.

### 6. REFERENCES CITED

All references cited herein are incorporated herein by reference in their entirety and for all purposes to the same extent as if each individual publication or patent or patent application was specifically and individually indicated to be incorporated by reference in its entirety herein for all purposes.

### 7. MODIFICATIONS

The present invention can be implemented as a computer program product that comprises a computer program mechanism embedded in a computer readable storage medium. For instance, the computer program product could contain the program modules shown in FIG. 3 or a program that embodies the flowchart illustrated in FIG. 4. These program modules can be stored on a CD-ROM, DVD, magnetic disk storage product, or any other computer readable data or program storage product. The program modules can also be embedded in permanent storage, such as ROM, one or more programmable chip, or one or more application specific integrated circuits (ASICs). Such permanent storage can be localized in a server, 802.11 access point, 802.11 wireless bridge/station, repeater, router, mobile phone, or other electronic devices.

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

What is claimed:

1. A method of optimizing a response of a computer based digital message campaign using computer based processing, the method comprising:
(A) electronically accessing a first plurality of digital message addresses of a first plurality of targeted recipients from one or more data structures containing digital message addresses of said first plurality of targeted recipients;
(B) creating a first plurality of digital messages, each digital message in the first plurality of digital messages comprising a plurality of elements independently selected from a library of elements based on one or more campaign rules, wherein
a first digital message in the first plurality of digital messages comprises a first plurality of elements independently selected from the library of elements based upon the one or more campaign rules for the computer based digital message campaign,
a second digital message in the first plurality of digital messages comprises a second plurality of elements independently selected from the library of elements based upon the one or more campaign rules, and
at least one element in the first plurality of elements is not in the second plurality of elements or at least one element in the second plurality of elements is not in the first plurality of elements;
(C) sending said first plurality of digital messages from a server over an electronic network to said first plurality of digital message addresses of said first plurality of targeted recipients, wherein
said first digital message is sent to a first digital message address in said first plurality of digital message addresses, and
said second digital message is sent to a second digital message address in said first plurality of digital message addresses,
(D) electronically tracking at least one selected response event occurring after said first plurality of digital messages is sent to said first plurality of digital message addresses of said first plurality of targeted recipients;
(E) segmenting the library of elements based upon one or more relationships between (i) differences in usages of elements in the first plurality of digital messages and (ii) the at least one selected response event, thereby discovering a relationship result;
(F) modifying, without human intervention, at least one of the one or more campaign rules based upon the relationship result;
(G) electronically accessing a second plurality of digital message addresses of a second plurality of targeted recipients from one or more data structures containing digital message addresses of said second plurality of targeted recipients;
(H) creating a second plurality of digital messages, each digital message in the second plurality of digital messages comprising a plurality of elements independently selected from the library of elements based on the one or more campaign rules as modified by the modifying (F); and
(I) sending said second plurality of digital messages from a server over an electronic network to said second plurality of digital message addresses of said second plurality of targeted recipients.

2. The method of claim 1, wherein said at least one selected response event is a single selected response event that is selected from the group consisting of a deliverability rate, a digital message open rate, a click through rate, a conversion rate, a purchase rate, a reply rate, and an unsubscribe rate, a deliverability rate during a predetermined time interval, a digital message open rate during a predetermined time interval, a click through rate during a predetermined time interval, a conversion rate during a predetermined time interval, a purchase rate during a predetermined time interval, a reply rate during a predetermined time interval, and an unsubscribe rate during a predetermined time interval.

3. The method of claim 1, wherein the library of elements comprises a predetermined subject line, a text message, a graphic, a clickable hyperlink, a position of a text message in a digital message, a position of a graphic in a digital message, a position of a clickable hyperlink, a background color of a digital message, a font used in a digital message, a point size for text in a digital message, a video clip, a position of a video clip in a digital message, a quality of a video clip in a digital message, or a compression format of a video clip in a digital message.

4. The method of claim 1, wherein the relationship result is a correlation between (i) the usage of a first element in the first plurality of digital messages and (ii) performance in the selected response event, wherein the correlation establishes that those digital messages in the first plurality of digital messages that incorporate the first element exhibit an overall improvement in the selected response event relative to those digital messages in the first plurality of digital messages that do not incorporate the first element.

5. The method of claim 4, wherein the modifying (F) comprises modifying a campaign rule in the one or more campaign rules so that the campaign rule specifies a new frequency of incorporation of the first element in a plurality of digital messages, wherein the new frequency is higher than an original frequency of incorporation of the first element in a plurality of digital messages specified by the campaign rule before the modifying (F), thereby causing the first element to be present in a higher percentage of the second plurality of digital messages than in the first plurality of digital messages.

6. The method of claim 4, wherein the modifying (F) comprises adding a new campaign rule to the one or more campaign rules for the computer based digital message campaign, wherein the new campaign rule specifies a frequency of incorporation of the first element in a plurality of digital messages.

7. The method of claim 1, wherein the relationship result is a correlation between (i) the usage of a first element in the first plurality of digital messages and (ii) performance in the selected response event, wherein the correlation establishes that those digital messages in the first plurality of digital messages that incorporate the first element exhibit an overall deterioration in the selected response event relative to those digital messages in the first plurality of digital messages that do not incorporate the first element.

8. The method of claim 7, wherein the modifying (F) comprises modifying a campaign rule in the one or more campaign rules so that the campaign rule specifies a new frequency of incorporation of the first element in a plurality of digital messages, wherein the new frequency is lower than an original frequency of incorporation of the first element in a plurality of digital messages specified by the campaign rule before the modifying (F), thereby causing the first element to be present in a lower percentage of the second plurality of digital messages than in the first plurality of digital messages.

9. The method of claim 7, wherein the modifying (F) comprises adding a new campaign rule to the one or more campaign rules for the computer based digital message campaign, wherein the new campaign rule specifies a frequency of incorporation of the first element in a plurality of digital messages.

10. The method of claim 1, wherein the relationship result is a correlation between (i) the usage of a first combination of elements in the first plurality of digital messages and (ii) performance in the selected response event, wherein the correlation establishes that those digital messages in the first plurality of digital messages that incorporate the first combination of elements exhibit an overall improvement in the selected response event relative to those digital messages in the first plurality of digital messages that do not incorporate the first combination of elements.

11. The method of claim 10, wherein the modifying (F) comprises modifying a campaign rule in the one or more campaign rules so that the campaign rule specifies a new frequency of incorporation of the first combination of elements in a plurality of digital messages, wherein the new frequency is higher than an original frequency of incorporation of the first combination of elements in a plurality of digital messages specified by the campaign rule before the modifying (F), thereby causing the first combination of elements to be present in a higher percentage of the second plurality of digital messages than in the first plurality of digital messages.

12. The method of claim 10, wherein the modifying (F) comprises adding a new campaign rule to the one or more campaign rules for the computer based digital message campaign, wherein the new campaign rule specifies a frequency of incorporation of the first combination of elements in a plurality of digital messages.

13. The method of claim 1, wherein the relationship result is a correlation between (i) the usage of a first combination of elements in the first plurality of digital messages and (ii) performance in the selected response event, wherein the correlation establishes that those digital messages in the first plurality of digital messages that incorporate the first combination of elements exhibit an overall deterioration in the selected response event relative to those digital messages in the first plurality of digital messages that do not incorporate the first combination of elements.

14. The method of claim 13, wherein the modifying (F) comprises modifying a campaign rule in the one or more campaign rules so that the campaign rule specifies a new frequency of incorporation of the first combination of elements in a plurality of digital messages, wherein the new frequency is lower than an original frequency of incorporation of the first combination of elements in a plurality of digital messages specified by the campaign rule before the modifying (F), thereby causing the first combination of elements to be present in a lower percentage of the second plurality of digital messages than in the first plurality of digital messages.

15. The method of claim 13, wherein the modifying (F) comprises adding a new campaign rule to the one or more campaign rules for the computer based digital message campaign, wherein the new campaign rule specifies a frequency of incorporation of the first combination of elements in a plurality of digital messages.

16. The method of claim 1, wherein
a variation in one or more demographics across the first plurality of targeted recipients is known, and wherein
said segmenting (E) further comprises determining whether (i) a variation in the presence or absence of a first element across the first plurality of digital messages and (ii) a variation in the performance of the at least one selected response event across the first plurality of targeted recipients are correlated conditional on a variation in the one or more demographics across the first plurality of targeted recipients,
wherein, when the segmenting (E) determines that (i) a variation in the presence or absence of a first element across the first plurality of digital messages and (ii) a variation in the performance of the at least one selected response event across the first plurality of targeted recipients are correlated conditional on a variation in the one or more demographics across the first plurality of targeted recipients, the modifying (F) comprises:
modifying a campaign rule in the one or more campaign rules so that the campaign rule specifies a new frequency of incorporation of the first element in those digital messages in a plurality of digital messages that are targeted to recipients that have the one or more demographics, wherein the new frequency is higher or lower than an original frequency of incorporation of the first element in those digital messages in a plurality of digital messages that are targeted to recipients that have the one or more demographics specified by the campaign rule before the modifying (F), thereby causing the first element to be present in a higher or lower percentage of the digital messages in the second plurality of digital messages that are targeted to recipients that have the one or more demographics than in the digital messages in the first plurality of digital messages that are targeted to recipients that have the one or more demographics.

17. The method of claim 16, wherein (i) a variation in the presence or absence of a first element across the first plurality of digital messages and (ii) a variation in the performance of the at least one selected response event across the first plurality of targeted recipients are correlated conditional on a variation in the one or more demographics across the first plurality of targeted recipients when
a variation in the presence or absence of a first element across the first plurality of digital messages given the variation in the one or more demographics across the first plurality of targeted recipients explains at least thirty percent of the variation in the performance of the at least one selected response event across the first plurality of targeted recipients.

18. The method of claim 16, wherein (i) a variation in the presence or absence of a first element across the first plurality of digital messages and (ii) a variation in the performance of the at least one selected response event across the first plurality of targeted recipients are correlated conditional on a variation in the one or more demographics across the first plurality of targeted recipients when
a variation in the presence or absence of a first element across the first plurality of digital messages given the variation in the one or more demographics across the first plurality of targeted recipients explains at least sixty percent of the variation in the performance of the at least one selected response event across the first plurality of targeted recipients.

19. The method of claim 1, wherein
a variation in one or more demographics across the first plurality of targeted recipients is known, and wherein
said segmenting (E) further comprises determining whether (i) a variation in the presence or absence of a first combination of elements across the first plurality of digital messages and (ii) a variation in the performance of the at least one selected response event across the first plurality of targeted recipients are correlated conditional on a variation in the one or more demographics across the first plurality of targeted recipients,
wherein, when the segmenting (E) determines that (i) a variation in the presence or absence of a first combination of elements across the first plurality of digital messages and (ii) a variation in the performance of the at least one selected response event across the first plurality of targeted recipients are correlated conditional on a variation in the one or more demographics across the first plurality of targeted recipients, the modifying (F) comprises:
modifying a campaign rule in the one or more campaign rules so that the campaign rule specifies a new frequency of incorporation of the first combination of elements in those digital messages in a plurality of digital messages that are targeted to recipients that have the one or more demographics, wherein the new frequency is higher or lower than an original frequency of incorporation of the first combination of elements in those digital messages in a plurality of digital messages that are targeted to recipients that have the one or more demographics specified by the campaign rule before the modifying (F), thereby causing the first combination of elements to be present in a higher or lower percentage of the digital messages in the second plurality of digital messages that are targeted to recipients that have the one or more demographics than in the digital messages in the first plurality of digital messages that are targeted to recipients that have the one or more demographics.

20. The method of claim 19, wherein (i) a variation in the presence or absence of the first combination of elements across the first plurality of digital messages and (ii) a variation in the performance of the at least one selected response event across the first plurality of targeted recipients are correlated conditional on a variation in the one or more demographics across the first plurality of targeted recipients when
a variation in the presence or absence of the first combination of elements across the first plurality of digital messages given the variation in the one or more demographics across the first plurality of targeted recipients explains at least thirty percent of the variation in the performance of the at least one selected response event across the first plurality of targeted recipients.

21. The method of claim 19, wherein (i) a variation in the presence or absence of the first combination of elements across the first plurality of digital messages and (ii) a variation in the performance of the at least one selected response event across the first plurality of targeted recipients are correlated conditional on a variation in the one or more demographics across the first plurality of targeted recipients when
a variation in the presence or absence of the first combination of elements across the first plurality of digital messages given the variation in the one or more demographics across the first plurality of targeted recipients explains at least sixty percent of the variation in the performance of the at least one selected response event across the first plurality of targeted recipients.

22. The method of claim 1, wherein
a variation in one or more demographics across the first plurality of targeted recipients is known, and wherein
said segmenting (E) further comprises determining whether (i) a variation in the presence or absence of a first element across the first plurality of digital messages and (ii) a variation in the performance of the at least one selected response event across the first plurality of targeted recipients are correlated conditional on a variation in the one or more demographics across the first plurality of targeted recipients,
wherein, when the segmenting (E) determines that (i) a variation in the presence or absence of a first element across the first plurality of digital messages and (ii) a variation in the performance of the at least one selected response event across the first plurality of targeted recipients are correlated conditional on a variation in the one or more demographics across the first plurality of targeted recipients, the modifying (F) comprises:
creating a campaign rule to be added to the one or more campaign rules, wherein the campaign rule specifies a frequency of incorporation of the first element in those digital messages in a plurality of digital message that are targeted to recipients that have the one or more demographics.

23. The method of claim 22, wherein (i) a variation in the presence or absence of a first element across the first plurality of digital messages and (ii) a variation in the performance of the at least one selected response event across the first plurality of targeted recipients are correlated conditional on a variation in the one or more demographics across the first plurality of targeted recipients when
a variation in the presence or absence of a first element across the first plurality of digital messages given the variation in the one or more demographics across the first plurality of targeted recipients explains at least thirty percent of the variation in the performance of the at least one selected response event across the first plurality of targeted recipients.

24. The method of claim 22, wherein (i) a variation in the presence or absence of a first element across the first plurality of digital messages and (ii) a variation in the performance of the at least one selected response event across the first plurality of targeted recipients are correlated conditional on a variation in the one or more demographics across the first plurality of targeted recipients when
a variation in the presence or absence of a first element across the first plurality of digital messages given the variation in the one or more demographics across the first plurality of targeted recipients explains at least sixty percent of the variation in the performance of the at least one selected response event across the first plurality of targeted recipients.

25. The method of claim 1, wherein
a variation in one or more demographics across the first plurality of targeted recipients is known, and wherein
said segmenting (E) further comprises determining whether (i) a variation in the presence or absence of a first combination of elements across the first plurality of digital messages and (ii) a variation in the performance of the at least one selected response event across the first plurality of targeted recipients are correlated conditional on a variation in the one or more demographics across the first plurality of targeted recipients,
wherein, when the segmenting (E) determines that (i) a variation in the presence or absence of a first combination of elements across the first plurality of digital messages and (ii) a variation in the performance of the at least one selected response event across the first plurality of targeted recipients are correlated conditional on a variation in the one or more demographics across the first plurality of targeted recipients, the modifying (F) comprises:
creating a campaign rule to be added to the one or more campaign rules, wherein the campaign rule specifies a frequency of incorporation of the first combination of elements in those digital messages in a plurality of digital messages that are targeted to recipients that have the one or more demographics.

26. The method of claim 25, wherein (i) a variation in the presence or absence of the first combination of elements across the first plurality of digital messages and (ii) a variation in the performance of the at least one selected response event across the first plurality of targeted recipients are correlated conditional on a variation in the one or more demographics across the first plurality of targeted recipients when
a variation in the presence or absence of the first combination of elements across the first plurality of digital messages given the variation in the one or more demographics across the first plurality of targeted recipients explains at least thirty percent of the variation in the performance of the at least one selected response event across the first plurality of targeted recipients.

27. The method of claim 25, wherein (i) a variation in the presence or absence of the first combination of elements across the first plurality of digital messages and (ii) a variation in the performance of the at least one selected response event across the first plurality of targeted recipients are correlated conditional on a variation in the one or more demographics across the first plurality of targeted recipients when
a variation in the presence or absence of the first combination of elements across the first plurality of digital messages given the variation in the one or more demographics across the first plurality of targeted recipients explains at least sixty percent of the variation in the performance of the at least one selected response event across the first plurality of targeted recipients.

28. The method of claim 16, wherein the one or more demographics is selected from the group consisting of an age of a targeted recipient, an income of a targeted recipient, a gender of a targeted recipient, a health status of a targeted recipient, a location of a targeted recipient, an internet connection speed used by a targeted recipient, a political association of a targeted recipient, a marital status of a targeted recipient, or a connection type used by the targeted recipient.

29. The method of claim 19, wherein the one or more demographics is selected from the group consisting of an age of a targeted recipient, an income of a targeted recipient, a gender of a targeted recipient, a health status of a targeted recipient, a location of a targeted recipient, an internet connection speed used by a targeted recipient, a political association of a targeted recipient, or a marital status of a targeted recipient.

30. The method of claim 22, wherein the one or more demographics is selected from the group consisting of an age of a targeted recipient, an income of a targeted recipient, a gender of a targeted recipient, a health status of a targeted recipient, a location of a targeted recipient, an internet connection speed used by a targeted recipient, a political association of a targeted recipient, or a marital status of a targeted recipient.

31. The method of claim 25, wherein the one or more demographics is selected from the group consisting of an age of a targeted recipient, an income of a targeted recipient, a gender of a targeted recipient, a health status of a targeted recipient, a location of a targeted recipient, an internet connection speed used by a targeted recipient, a political association of a targeted recipient, or a marital status of a targeted recipient.

32. The method of claim 1, wherein the segmenting (E) is determined using a pattern classification technique.

33. The method of claim 1, wherein the segmenting (E) is determined using Bayesian analysis, regression, or clustering.

34. The method of claim 1, wherein the segmenting (E) is determined by Bayesian analysis, a Parzen window, kₙ-Nearest-neighbor estimation, fuzzy classification, a linear discriminant function, a Ho-Kashyap procedure, a support vector machine, a neural network, simulated annealing, deterministic simulated annealing, a genetic algorithms, a decision trees, a classification and regression tree (CAR), a mixture-of-expert model, a chi-square test, a student's t-test, regression, a linear regression, a Kernel method, an additive trees, or a Markov network.

35. The method of claim 1, wherein the segmenting (E) comprises identifying elements in the library of elements that affect the variation in the performance of the at least one selected response event across the first plurality of targeted recipients by eliminating from consideration one or more elements in the library of elements that do not affect the variation in the performance of the at least one selected response event across the first plurality of targeted recipients.

36. The method of claim 35, wherein the one or more elements in the library of elements that do not affect the variation in the performance of the at least one selected response event across the first plurality of targeted recipients are identified by backward stepwise regression.

37. The method of claim 1, wherein
one or more demographics is known for each targeted recipient in the first plurality of targeted recipients, and wherein
said segmenting (E) further comprises discovering a demographic that, in conjunction with a respective property of one or more elements used in one or more of the first plurality of digital messages, improves the at least one selected response event, and
said modifying (F) comprises forming a campaign rule that is specific to the discovered demographic.

38. The method of claim 37, wherein the discovering is accomplished using a pattern classification technique.

39. The method of claim 37, wherein the discovering is accomplished by Bayesian analysis, a Parzen window, kₙ-Nearest-neighbor estimation, fuzzy classification, a linear discriminant function, a Ho-Kashyap procedure, a support vector machine, a neural network, simulated annealing, deterministic simulated annealing, a genetic algorithms, a decision trees, a classification and regression tree (CAR), a mixture-of-expert model, a chi-square test, a student's t-test, regression, a linear regression, a Kernel method, an additive trees, or a Markov network.

40. The method of claim 1, wherein
said segmenting (E) further comprises discovering one or more elements used in one or more of the first plurality of digital messages that improves the at least one selected response event, and
said modifying (F) comprises forming a campaign rule that up-weights the one or more elements for incorporation into the second plurality of digital messages.

41. The method of claim 1, wherein a campaign rule in the one or more campaign rules specifies a percentage of time an element in the library of elements is to be incorporated into a plurality of digital messages.

42. The method of claim 1, wherein a campaign rule in the one or more campaign rules specifies a numeric probability that an element in the library of elements is to be incorporated into a digital message in the plurality of digital messages.

43. The method of claim 1, wherein a campaign rule in the one or more campaign rules specifies an allowed percentage range for incorporation of an element or a combination of elements in the library of elements into a plurality of digital messages.

44. The method of claim 1, wherein a campaign rule in the one or more campaign rules specifies a percentage of time an element or a combination of elements in the library of elements is to be incorporated into a plurality of digital messages.

45. The method of claim 1, wherein a campaign rule in the one or more campaign rules specifies a probability that an element or a combination of elements in the library of elements is to be incorporated into a digital message in a plurality of digital messages.

46. The method of claim 1, wherein a campaign rule in the one or more campaign rules specifies an allowed number of times or an allowed range of times an element or a combination of elements in the library of elements can be incorporated into a plurality of digital messages.

47. The method of claim 1, wherein steps (A) through (F) are repeated one or more times prior to step (G), and wherein
each repeat of steps (A) through (F) is for a new first plurality of targeted recipients, and
the one or more one or more campaign rules of each repeated step (B) are the one or more campaign rules of the prior implemented modifying step (F).

48. The method of claim 1, wherein each difference in usage of an element considered in the segmenting (E) comprises an absence or a presence of an element in respective digital messages in the first plurality of digital messages.

49. A method of optimizing a response of a computer based digital message campaign using computer based processing, the method comprising:
(A) electronically accessing a first plurality of digital message addresses of a first plurality of targeted recipients from one or more data structures containing digital message addresses of said first plurality of targeted recipients, wherein a variation in one or more demographics across the first plurality of targeted recipients is known;
(B) creating a first plurality of digital messages, each digital message in the first plurality of digital messages comprising a plurality of elements independently selected from a library of elements based on one or more campaign rules, wherein
a first digital message in the first plurality of digital messages comprises a first plurality of elements independently selected from the library of elements based upon the one or more campaign rules for the computer based digital message campaign,
a second digital message in the first plurality of digital messages comprises a second plurality of elements independently selected from the library of elements based upon the one or more campaign rules, and
at least one element in the first plurality of elements is not in the second plurality of elements or at least one element in the second plurality of elements is not in the first plurality of elements;
(C) sending said first plurality of digital messages from a server over an electronic network to said first plurality of digital message addresses of said first plurality of targeted recipients, wherein
said first digital message is sent to a first digital message address in said first plurality of digital message addresses, and
said second digital message is sent to a second digital message address in said first plurality of digital message addresses;
(D) electronically tracking at least one selected response event occurring after said first plurality of digital messages is sent to said first plurality of digital message addresses of said first plurality of targeted recipients;
(E) determining whether (i) a variation in the presence or absence of a first element across the first plurality of digital messages and (ii) a variation in the performance of the at least one selected response event across the first plurality of targeted recipients are correlated conditional on a variation in the one or more demographics across the first plurality of targeted recipients;
(F) modifying, when (i) and (ii) of (E) are correlated conditional on a variation in the one or more demographics across the first plurality of targeted recipients, a campaign rule in the one or more campaign rules so that the campaign rule specifies a new frequency of incorporation of the first element in those digital messages in a plurality of digital messages that are targeted to recipients that have the one or more demographics, wherein the new frequency is higher or lower than an original frequency of incorporation of the first element in those digital messages in a plurality of digital messages that are targeted to recipients that have the one or more demographics specified by the campaign rule before the modifying (E), thereby causing the first element to be present in a higher or lower percentage of the digital messages in a second plurality of digital messages that are targeted to recipients that have the one or more demographics than in the digital messages in the first plurality of digital messages that are targeted to recipients that have the one or more demographics;
(F) electronically accessing the second plurality of digital message addresses of a second plurality of targeted recipients from one or more data structures containing digital message addresses of said second plurality of targeted recipients, wherein a variation in one or more demographics across the first plurality of targeted recipients is known;
(G) creating a second plurality of digital messages, each digital message in the second plurality of digital messages comprising a plurality of elements independently selected from the library of elements based on the one or more campaign rules as modified by the modifying (E); and
(H) sending said second plurality of digital messages from a server over an electronic network to said second plurality of digital message addresses of said second plurality of targeted recipients.

50. A method of optimizing a response of a computer based digital message campaign using computer based processing, the method comprising:
(A) creating a first plurality of digital messages, each digital message in the first plurality of digital message comprising a plurality of elements independently selected from a library of elements based on one or more campaign rules, wherein
a first digital message in the first plurality of digital messages comprises a first plurality of elements independently selected from a library of elements based upon the one or more campaign rules for the computer based digital message campaign,
a second digital message in the first plurality of digital messages comprises a second plurality of elements independently selected from the library of elements based upon the one or more campaign rules, and
at least one element in the first plurality of elements is not in the second plurality of elements or at least one element in the second plurality of elements is not in the first plurality of elements;
(B) sending said first plurality of digital messages from a server over an electronic network to a first plurality of digital message addresses of a first plurality of targeted recipients, wherein
said first digital message is sent to a first digital message address in said first plurality of digital message addresses, and
said second digital message is sent to a second digital message address in said first plurality of digital message addresses,
(C) electronically tracking at least one selected response event occurring after said first plurality of digital messages is sent to said first plurality of digital message addresses of said first plurality of targeted recipients;
(D) segmenting the library of elements based upon one or more relationships between (i) differences in usages of elements in the first plurality of digital messages and (ii) the at least one selected response event, thereby discovering a relationship result;
(E) modifying at least one of the one or more campaign rules based upon the relationship result;
(F) creating a second plurality of digital messages, each digital message in the second plurality of digital messages comprising a plurality of elements independently selected from the library of elements based on the one or more campaign rules as modified by the modifying (E); and
(G) sending said second plurality of digital messages from a server over an electronic network to a second plurality of digital message addresses of a second plurality of targeted recipients.

51. A method of optimizing a response of a computer based digital message campaign using computer based processing, the method comprising:
(A) creating a first plurality of digital messages, each digital messages in the first plurality of digital messages comprising a plurality of elements independently selected from a library of elements based on one or more campaign rules, wherein
a first digital message in the first plurality of digital messages comprises a first plurality of elements independently selected from the library of elements based upon the one or more campaign rules for the computer based digital message campaign,
a second digital message in the first plurality of digital messages comprises a second plurality of elements independently selected from the library of elements based upon the one or more campaign rules, and
at least one element in the first plurality of elements is not in the second plurality of elements or at least one element in the second plurality of elements is not in the first plurality of elements;
(B) sending said first plurality of digital messages from a server over an electronic network to a first plurality of digital message addresses of a first plurality of targeted recipients, wherein
said first digital message is sent to a first digital message address in said first plurality of digital message addresses,
said second digital message is sent to a second digital message address in said first plurality of digital message addresses, and
a variation in one or more demographics across the first plurality of targeted recipients is known;
(C) electronically tracking at least one selected response event occurring after said first plurality of digital messages is sent to said first plurality of digital message addresses of said first plurality of targeted recipients;
(D) determining whether (i) a variation in the presence or absence of a first element across the first plurality of digital messages and (ii) a variation in the performance of the at least one selected response event across the first plurality of targeted recipients are correlated conditional on a variation in the one or more demographics across the first plurality of targeted recipients,
wherein, when the segmenting (D) determines that (i) a variation in the presence or absence of a first element across the first plurality of digital messages and (ii) a variation in the performance of the at least one selected response event across the first plurality of targeted recipients are correlated conditional on a variation in the one or more demographics across the first plurality of targeted recipients, the determining (D) further comprises:
modifying a campaign rule in the one or more campaign rules so that the campaign rule specifies a new frequency of incorporation of the first element in those digital messages in a plurality of digital messages that are targeted to recipients that have the one or more demographics, wherein the new frequency is higher or lower than an original frequency of incorporation of the first element in those digital messages in a plurality of digital messages that are targeted to recipients that have the one or more demographics specified by the campaign rule before the determining (D), thereby causing the first element to be present in a higher or lower percentage of the digital messages in a second plurality of digital messages that are targeted to recipients that have the one or more demographics than in the digital messages in the first plurality of digital messages that are targeted to recipients that have the one or more demographics.
(E) creating a second plurality of digital messages, each digital message in the second plurality of digital messages comprising a plurality of elements independently selected from the library of elements based on the one or more campaign rules as modified by the determining (D); and
(F) sending said second plurality of digital messages from a server over an electronic network to said second plurality of digital message addresses of said second plurality of targeted recipients, wherein a variation in one or more demographics across the first plurality of targeted recipients is known.

52. A method of optimizing a response of a computer based digital message campaign using computer based processing, the method comprising:
(A) sending a first plurality of digital messages from a server over an electronic network to a first plurality of digital message addresses of a first plurality of targeted recipients, wherein
a first digital message in the first plurality of digital messages is sent to a first digital message address in said first plurality of digital message addresses,
a second digital message in the first plurality of digital messages is sent to a second digital message address in said first plurality of digital message addresses,
a variation in one or more demographics across the first plurality of targeted recipients is known,
each digital message in the first plurality of digital messages comprising a plurality of elements independently selected from a library of elements based on one or more campaign rules,
said first digital message comprises a first plurality of elements independently selected from the library of elements based upon the one or more campaign rules for the computer based digital message campaign,
said second digital message comprises a second plurality of elements independently selected from the library of elements based upon the one or more campaign rules, and
at least one element in the first plurality of elements is not in the second plurality of elements or at least one element in the second plurality of elements is not in the first plurality of elements;
(B) electronically tracking at least one selected response event occurring after said first plurality of digital messages is sent to said first plurality of digital message addresses of said first plurality of targeted recipients;
(C) determining whether (i) a variation in the presence or absence of a first element or a first combination of elements across the first plurality of digital messages and (ii) a variation in the performance of the at least one selected response event across the first plurality of targeted recipients are correlated conditional on a variation in the one or more demographics across the first plurality of targeted recipients,
wherein, when the segmenting (D) determines that (i) a variation in the presence or absence of a first element or a variation in the presence or absence of a first combination of elements across the first plurality of digital messages and (ii) a variation in the performance of the at least one selected response event across the first plurality of targeted recipients are correlated conditional on a variation in the one or more demographics across the first plurality of targeted recipients, the determining (C) further comprises:
modifying a campaign rule in the one or more campaign rules so that the campaign rule specifies a new frequency of incorporation of the first element or the first combination of elements in those digital messages in a plurality of digital messages that are targeted to recipients that have the one or more demographics, wherein the new frequency is higher or lower than an original frequency of incorporation of the first element or the first combination of elements in those digital messages in a plurality of digital messages that are targeted to recipients that have the one or more demographics specified by the campaign rule before the determining (C), thereby causing the first element or the first combination of elements to be present in a higher or lower percentage of the digital messages in a second plurality of digital messages that are targeted to recipients that have the one or more demographics than in the digital messages in the first plurality of digital messages that are targeted to recipients that have the one or more demographics,
(D) creating a second plurality of digital messages, each digital message in the second plurality of digital messages in the form of a digital messages, each digital message in the second plurality of digital messages comprising a plurality of elements independently selected from the library of elements based on the one or more campaign rules as modified by the determining (C); and
(E) sending said second plurality of digital messages from a server over an electronic network to said second plurality of digital message addresses of said second plurality of targeted recipients, wherein a variation in one or more demographics across the first plurality of targeted recipients is known.

53. A method of optimizing a response of a computer based digital message digital campaign using computer based processing, the method comprising:
(A) sending a first plurality of digital messages from a server over an electronic network to a first plurality of digital message addresses of a first plurality of targeted recipients, wherein
a first digital message in the first plurality of digital messages is sent to a first digital message address in said first plurality of digital message addresses,
a second digital message in the first plurality of digital messages is sent to a second digital message address in said first plurality of digital message addresses,
a variation in one or more demographics across the first plurality of targeted recipients is known,
each digital message in the first plurality of digital messages comprising a plurality of elements independently selected from a library of elements based on one or more campaign rules,
said first digital message comprises a first plurality of elements independently selected from the library of elements based upon the one or more campaign rules for the computer based digital message campaign,
said second digital message comprises a second plurality of elements independently selected from the library of elements based upon the one or more campaign rules, and
at least one element in the first plurality of elements is not in the second plurality of elements or at least one element in the second plurality of elements is not in the first plurality of elements;
(B) electronically tracking at least one selected response event occurring after said first plurality of digital messages is sent to said first plurality of digital message addresses of said first plurality of targeted recipients;
(C) determining whether (i) a variation in the presence or absence of a first element or a first combination of elements across the first plurality of digital messages and (ii) a variation in the performance of the at least one selected response event across the first plurality of targeted recipients are correlated conditional on a variation in the one or more demographics across the first plurality of targeted recipients,
wherein, when the segmenting (D) determines that (i) a variation in the presence or absence of a first element or a variation in the presence or absence of a first combination of elements across the first plurality of digital messages and (ii) a variation in the performance of the at least one selected response event across the first plurality of targeted recipients are correlated conditional on a variation in the one or more demographics across the first plurality of targeted recipients, the determining (C) further comprises:
creating a campaign rule to be included in the one or more campaign rules, the campaign rule specifying a frequency of incorporation of the first element or the first combination of elements in those digital messages in a plurality of digital messages that are targeted to recipients that have the one or more demographics;
(D) creating a second plurality of digital messages, each digital message in the second plurality of digital messages in the form of a digital message, each digital message in the second plurality of digital messages comprising a plurality of elements independently selected from the library of elements based on the one or more campaign rules as modified by the determining (C); and
(E) sending said second plurality of digital messages from a server over an electronic network to said second plurality of digital message addresses of said second plurality of targeted recipients, wherein a variation in one or more demographics across the first plurality of targeted recipients is known.

54. A computer program product for use in conjunction with a computer system, the computer program product comprising a computer readable storage medium and a computer program mechanism embedded therein, the computer program mechanism for optimizing a response of a computer based digital message campaign using computer based processing, the computer program mechanism comprising instructions for:
(A) electronically accessing a first plurality of digital message addresses of a first plurality of targeted recipients from one or more data structures containing digital message addresses of said first plurality of targeted recipients;
(B) creating a first plurality of digital messages, each digital message in the first plurality of digital messages comprising a plurality of elements independently selected from a library of elements based on one or more campaign rules, wherein
a first digital message in the first plurality of digital messages comprises a first plurality of elements independently selected from the library of elements based upon the one or more campaign rules for the computer based digital message campaign,
a second digital message in the first plurality of digital messages comprises a second plurality of elements independently selected from the library of elements based upon the one or more campaign rules, and
at least one element in the first plurality of elements is not in the second plurality of elements or at least one element in the second plurality of elements is not in the first plurality of elements;
(C) sending said first plurality of digital messages from a server over an electronic network to said first plurality of digital message addresses of said first plurality of targeted recipients, wherein
said first digital message is sent to a first digital message address in said first plurality of digital message addresses, and
said second digital message is sent to a second digital message address in said first plurality of digital message addresses,
(D) electronically tracking at least one selected response event occurring after said first plurality of digital messages is sent to said first plurality of digital message addresses of said first plurality of targeted recipients;
(E) segmenting the library of elements based upon one or more relationships between (i) differences in usages of elements in the first plurality of digital messages and (ii) the at least one selected response event, thereby discovering a relationship result;
(F) modifying at least one of the one or more campaign rules based upon the relationship result;
(G) electronically accessing a second plurality of digital message addresses of a second plurality of targeted recipients from one or more data structures containing digital message addresses of said second plurality of targeted recipients;
(H) creating a second plurality of digital messages, each digital message in the second plurality of digital messages comprising a plurality of elements independently selected from the library of elements based on the one or more campaign rules as modified by the modifying (F); and
(I) sending said second plurality of digital messages from a server over an electronic network to said second plurality of digital message addresses of said second plurality of targeted recipients.

55. A computer system for optimizing a response of a computer based digital message campaign using computer based processing, the computer system comprising:
a central processing unit; and
a memory, coupled to the central processing unit, the memory comprising instructions for:
(A) electronically accessing a first plurality of digital message addresses of a first plurality of targeted recipients from one or more data structures containing digital message addresses of said first plurality of targeted recipients;
(B) creating a first plurality of digital messages, each digital message in the first plurality of digital messages comprising a plurality of elements independently selected from a library of elements based on one or more campaign rules, wherein
a first digital message in the first plurality of digital messages comprises a first plurality of elements independently selected from the library of elements based upon the one or more campaign rules for the computer based digital message campaign,
a second digital message in the first plurality of digital messages comprises a second plurality of elements independently selected from the library of elements based upon the one or more campaign rules, and
at least one element in the first plurality of elements is not in the second plurality of elements or at least one element in the second plurality of elements is not in the first plurality of elements;
(C) sending said first plurality of digital messages from a server over an electronic network to said first plurality of digital message addresses of said first plurality of targeted recipients, wherein
said first digital message is sent to a first digital message address in said first plurality of digital message addresses, and
said second digital message is sent to a second digital message address in said first plurality of digital message addresses,
(D) electronically tracking at least one selected response event occurring after said first plurality of digital messages is sent to said first plurality of digital message addresses of said first plurality of targeted recipients;
(E) segmenting the library of elements based upon one or more relationships between (i) differences in usages of elements in the first plurality of digital messages and (ii) the at least one selected response event, thereby discovering a relationship result;
(F) modifying at least one of the one or more campaign rules based upon the relationship result;
(G) electronically accessing a second plurality of digital message addresses of a second plurality of targeted recipients from one or more data structures containing digital messages of said second plurality of targeted recipients;
(H) creating a second plurality of digital messages, each digital message in the second plurality of digital messages comprising a plurality of elements independently selected from the library of elements based on the one or more campaign rules as modified by the modifying (F); and
(I) sending said second plurality of digital messages from a server over an electronic network to said second plurality of digital message addresses of said second plurality of targeted recipients.

56. A computer program product for use in conjunction with a computer system, the computer program product comprising a computer readable storage medium and a computer program mechanism embedded therein, the computer program mechanism for optimizing a response of a computer based digital message campaign using computer based processing, the computer program mechanism comprising instructions for:
(A) sending a first plurality of digital messages from a server over an electronic network to a first plurality of digital message addresses of a first plurality of targeted recipients, wherein
a first digital message in the first plurality of digital messages is sent to a first digital message address in said first plurality of digital message addresses,
a second digital message in the first plurality of digital messages is sent to a second digital message address in said first plurality of digital message addresses,
a variation in one or more demographics across the first plurality of targeted recipients is known,
each digital message in the first plurality of digital messages comprising a plurality of elements independently selected from a library of elements based on one or more campaign rules,
said first digital message comprises a first plurality of elements independently selected from the library of elements based upon the one or more campaign rules for the computer based digital message campaign,
said second digital message comprises a second plurality of elements independently selected from the library of elements based upon the one or more campaign rules, and
at least one element in the first plurality of elements is not in the second plurality of elements or at least one element in the second plurality of elements is not in the first plurality of elements;
(B) electronically tracking at least one selected response event occurring after said first plurality of digital messages is sent to said first plurality of digital message addresses of said first plurality of targeted recipients;
(C) determining whether (i) a variation in the presence or absence of a first element or a first combination of elements across the first plurality of digital messages and (ii) a variation in the performance of the at least one selected response event across the first plurality of targeted recipients are correlated conditional on a variation in the one or more demographics across the first plurality of targeted recipients,
wherein, when the determining (C) determines that (i) a variation in the presence or absence of a first element or a variation in the presence or absence of a first combination of elements across the first plurality of digital messages and (ii) a variation in the performance of the at least one selected response event across the first plurality of targeted recipients are correlated conditional on a variation in the one or more demographics across the first plurality of targeted recipients, the determining (C) further comprises:
modifying a campaign rule in the one or more campaign rules so that the campaign rule specifies a new frequency of incorporation of the first element or the first combination of elements in those digital messages in a plurality of digital messages that are targeted to recipients that have the one or more demographics, wherein the new frequency is higher or lower than an original frequency of incorporation of the first element or the first combination of elements in those digital messages in a plurality of digital messages that are targeted to recipients that have the one or more demographics specified by the campaign rule before the determining (C), thereby causing the first element or the first combination of elements to be present in a higher or lower percentage of the digital messages in a second plurality of digital messages that are targeted to recipients that have the one or more demographics than in the digital messages in the first plurality of digital messages that are targeted to recipients that have the one or more demographics,
(D) creating a second plurality of digital messages, each digital message in the second plurality of digital messages comprising a plurality of elements independently selected from the library of elements based on the one or more campaign rules as modified by the determining (C); and
(E) sending said second plurality of digital messages from al server over an electronic network to said second plurality of digital message addresses of said second plurality of targeted recipients, wherein a variation in one or more demographics across the first plurality of targeted recipients is known.

57. A computer program product for use in conjunction with a computer system, the computer program product comprising a computer readable storage medium and a computer program mechanism embedded therein, the computer program mechanism for optimizing a response of a computer based digital messages campaign using computer based processing, the computer program mechanism comprising instructions for:
(A) sending a first plurality of digital messages from a server over an electronic network to a first plurality of digital message addresses of a first plurality of targeted recipients, wherein
a first digital message in the first plurality of digital messages is sent to a first digital message address in said first plurality of digital message addresses,
a second digital message in the first plurality of digital messages is sent to a second digital message address in said first plurality of digital message addresses,
a variation in one or more demographics across the first plurality of targeted recipients is known,
each digital message in the first plurality of digital messages comprising a plurality of elements independently selected from a library of elements based on one or more campaign rules,
said first digital message comprises a first plurality of elements independently selected from the library of elements based upon the one or more campaign rules for the computer based digital message campaign,
said second digital message comprises a second plurality of elements independently selected from the library of elements based upon the one or more campaign rules, and
at least one element in the first plurality of elements is not in the second plurality of elements or at least one element in the second plurality of elements is not in the first plurality of elements;
(B) electronically tracking at least one selected response event occurring after said first plurality of digital messages is sent to said first plurality of digital message addresses of said first plurality of targeted recipients;
(C) determining whether (i) a variation in the presence or absence of a first element or a first combination of elements across the first plurality of digital messages and (ii) a variation in the performance of the at least one selected response event across the first plurality of targeted recipients are correlated conditional on a variation in the one or more demographics across the first plurality of targeted recipients,
wherein, when the determining (C) determines that (i) a variation in the presence or absence of a first element or a variation in the presence or absence of a first combination of elements across the first plurality of digital messages and (ii) a variation in the performance of the at least one selected response event across the first plurality of targeted recipients are correlated conditional on a variation in the one or more demographics across the first plurality of targeted recipients, the determining (C) further comprises:
creating a campaign rule to be included in the one or more campaign rules, the campaign rule specifying a frequency of incorporation of the first element or the first combination of elements in those digital messages in a plurality of digital messages that are targeted to recipients that have the one or more demographics;
(D) creating a second plurality of digital messages, each digital message in the second plurality of digital messages in the form of an digital message, each digital message in the second plurality of digital messages comprising a plurality of elements independently selected from the library of elements based on the one or more campaign rules as modified by the determining (C); and
(E) sending said second plurality of digital messages from a server over an electronic network to said second plurality of digital message addresses of said second plurality of targeted recipients, wherein a variation in one or more demographics across the first plurality of targeted recipients is known.

58. A computer system for optimizing a response of a computer based digital message campaign using computer based processing, the computer system comprising:
a central processing unit; and
a memory, coupled to the central processing unit, the memory comprising instructions for:
(A) sending a first plurality of digital message from a server over an electronic network to a first plurality of digital message addresses of a first plurality of targeted recipients, wherein
a first digital message in the first plurality of digital messages is sent to a first digital message address in said first plurality of digital message addresses,
a second digital message in the first plurality of digital messages is sent to a second digital message address in said first plurality of digital message addresses,
a variation in one or more demographics across the first plurality of targeted recipients is known,
each digital message in the first plurality of digital messages comprising a plurality of elements independently selected from a library of elements based on one or more campaign rules,
said first digital message comprises a first plurality of elements independently selected from the library of elements based upon the one or more campaign rules for the computer based digital message campaign,
said second digital message comprises a second plurality of elements independently selected from the library of elements based upon the one or more campaign rules, and
at least one element in the first plurality of elements is not in the second plurality of elements or at least one element in the second plurality of elements is not in the first plurality of elements;
(B) electronically tracking at least one selected response event occurring after said first plurality of digital messages is sent to said first plurality of digital message addresses of said first plurality of targeted recipients;
(C) determining whether (i) a variation in the presence or absence of a first element or a first combination of elements across the first plurality of digital messages and (ii) a variation in the performance of the at least one selected response event across the first plurality of targeted recipients are correlated conditional on a variation in the one or more demographics across the first plurality of targeted recipients,
wherein, when the segmenting (D) determines that (i) a variation in the presence or absence of a first element or a variation in the presence or absence of a first combination of elements across the first plurality of digital messages and (ii) a variation in the performance of the at least one selected response event across the first plurality of targeted recipients are correlated conditional on a variation in the one or more demographics across the first plurality of targeted recipients, the determining (C) further comprises:
modifying a campaign rule in the one or more campaign rules so that the campaign rule specifies a new frequency of incorporation of the first element or the first combination of elements in those digital messages in a plurality of digital messages that are targeted to recipients that have the one or more demographics, wherein the new frequency is higher or lower than an original frequency of incorporation of the first element or the first combination of elements in those digital messages in a plurality of digital messages that are targeted to recipients that have the one or more demographics specified by the campaign rule before the determining (C), thereby causing the first element or the first combination of elements to be present in a higher or lower percentage of the digital messages in a second plurality of digital messages that are targeted to recipients that have the one or more demographics than in the digital messages in the first plurality of digital messages that are targeted to recipients that have the one or more demographics,
(D) creating a second plurality of digital messages, each digital message in the second plurality of digital messages in the form of an digital message, each digital message in the second plurality of digital messages comprising a plurality of elements independently selected from the library of elements based on the one or more campaign rules as modified by the determining (C); and
(E) sending said second plurality of digital messages from a server over an electronic network to said second plurality of digital message addresses of said second plurality of targeted recipients, wherein a variation in one or more demographics across the first plurality of targeted recipients is known.

59. A computer system for optimizing a response of a computer based digital message campaign using computer based processing, the computer system comprising:
a central processing unit; and
a memory, coupled to the central processing unit, the memory comprising instructions for:
(A) sending a first plurality of digital messages from a server over an electronic network to a first plurality of digital message addresses of a first plurality of targeted recipients, wherein
a first digital message in the first plurality of digital messages is sent to a first digital message address in said first plurality of digital message addresses,
a second digital message in the first plurality of digital messages is sent to a second digital message address in said first plurality of digital message addresses,
a variation in one or more demographics across the first plurality of targeted recipients is known,
each digital message in the first plurality of digital messages comprising a plurality of elements independently selected from a library of elements based on one or more campaign rules,
said first digital message comprises a first plurality of elements independently selected from the library of elements based upon the one or more campaign rules for the computer based digital message campaign,
said second digital message comprises a second plurality of elements independently selected from the library of elements based upon the one or more campaign rules, and
at least one element in the first plurality of elements is not in the second plurality of elements or at least one element in the second plurality of elements is not in the first plurality of elements;
(B) electronically tracking at least one selected response event occurring after said first plurality of digital messages is sent to said first plurality of digital messages addresses of said first plurality of targeted recipients;
(C) determining whether (i) a variation in the presence or absence of a first element or a first combination of elements across the first plurality of digital messages and (ii) a variation in the performance of the at least one selected response event across the first plurality of targeted recipients are correlated conditional on a variation in the one or more demographics across the first plurality of targeted recipients,
wherein, when the determining (C) determines that (i) a variation in the presence or absence of a first element or a variation in the presence or absence of a first combination of elements across the first plurality of digital messages and (ii) a variation in the performance of the at least one selected response events across the first plurality of targeted recipients are correlated conditional on a variation in the one or more demographics across the first plurality of targeted recipients, the determining (C) further comprises:
creating a campaign rule to be included in the one or more campaign rules, the campaign rule specifying a frequency of incorporation of the first element or the first combination of elements in those digital messages in a plurality of digital messages that are targeted to recipients that have the one or more demographics;
(D) creating a second plurality of digital messages, each digital message in the second plurality of digital messages comprising a plurality of elements independently selected from the library of elements based on the one or more campaign rules as modified by the determining (C); and
(E) sending said second plurality of digital messages from a server over an electronic network to said second plurality of digital message addresses of said second plurality of targeted recipients, wherein a variation in one or more demographics across the first plurality of targeted recipients is known.

60. A method of optimizing a response of a computer based digital message campaign using computer based processing, the method comprising:
(A) electronically accessing a first plurality of digital message addresses of a first plurality of targeted recipients from one or more data structures containing digital message addresses of said first plurality of targeted recipients;
(B) creating a first plurality of digital messages, each digital message in the first plurality of digital message comprising a plurality of elements independently selected from a library of elements based on one or more campaign rules;
(C) sending said first plurality of digital messages from a server over an electronic network to said first plurality of digital message addresses of said first plurality of targeted recipients, wherein
a first digital message is sent to a first digital message address in said first plurality of digital message addresses associated with a first targeted recipient having a first demographic, and
a second digital message is sent to a second digital message address in said first plurality of digital message addresses having a second demographic,
wherein the first demographic is different than the second demographic;
(D) electronically tracking at least one selected response event occurring after said first plurality of digital messages is sent to said first plurality of digital message addresses of said first plurality of targeted recipients;
(E) segmenting the library of elements based upon one or more relationships between (i) differences in one or more demographics in the first plurality of digital messages and (ii) the at least one selected response event, thereby discovering a relationship result;
(F) modifying at least one of the one or more campaign rules based upon the relationship result, or creating a campaign rule to be added to the one or more campaign results based upon the relationship result;
(G) electronically accessing a second plurality of digital message addresses of a second plurality of targeted recipients from one or more data structures containing digital message addresses of said second plurality of targeted recipients;
(H) creating a second plurality of digital messages, each digital message in the second plurality of digital messages comprising a plurality of elements independently selected from the library of elements based on the one or more campaign rules as modified by the modifying (F); and
(I) sending said second plurality of digital messages from a server over an electronic network to said second plurality of digital message addresses of said second plurality of targeted recipients.

61. The method of claim 1, wherein the first digital message is a first e-mail and the second digital message is a second e-mail.

62. The method of claim 49, wherein the first digital message is a first e-mail and the second digital message is a second e-mail.

63. The method of claim 50, wherein the first digital message is a first e-mail and the second digital message is a second e-mail.

64. The method of claim 51, wherein the first digital message is a first e-mail and the second digital message is a second e-mail.

65. The method of claim 52, wherein the first digital message is a first e-mail and the second digital message is a second e-mail.

66. The method of claim 53, wherein the first digital message is a first e-mail and the second digital message is a second e-mail.

67. The computer program product of claim 54, wherein the first digital message is a first e-mail and the second digital message is a second e-mail.

68. The computer system of claim 55, wherein the first digital message is a first e-mail and the second digital message is a second e-mail.

69. The computer program product of claim 56, wherein the first digital message is a first e-mail and the second digital message is a second e-mail.

70. The computer system of claim 58, wherein the first digital message is a first e-mail and the second digital message is a second e-mail.

71. The computer system of claim 59, wherein the first digital message is a first e-mail and the second digital message is a second e-mail.

72. The method of claim 60, wherein the first digital message is a first e-mail and the second digital message is a second e-mail.

73. A method of target discovery, the method comprising:
(A) sending a first plurality of digital messages from a server over an electronic network to a first plurality of digital message addresses of a first plurality of targeted recipients, wherein
a variation in a first demographic across the first plurality of targeted recipients is known, and
a variation in a second demographic across the first plurality of targeted recipients is known;
(B) electronically tracking, using a computer, at least one selected response event occurring after said first plurality of digital messages is sent to said first plurality of digital message addresses of said first plurality of targeted recipients;
(C) determining whether there is a correlation between (i) a variation in the first demographic across the first plurality of targeted recipients and (ii) a variation in the performance of the at least one selected response event across the first plurality of targeted recipients;
(D) identifying whether, when there is a correlation between (i) and (ii) of the determining (C), there is a correlation between (i) a variation in the first demographic across the first plurality of targeted recipients and (ii) a variation in the second demographic across the first plurality of targeted recipients; and
(F) determining, when there is a correlation between (i) and (ii) of the determining (C) and there is a correlation between (i) and (ii) of the determining (D), whether one or more targeted recipients in a second plurality of targeted recipients have said first demographic or said second demographic by comparing (i) performance of the at least one selected response event by the one or more targeted recipients in the second plurality of targeted recipients to (ii) the performance of the at least one selected response event by those targeted recipients in the first plurality of targeted recipients that have both said first demographic and said second demographic.

74. The method of claim 73, wherein said at least one selected response event is a single selected response event that is selected from the group consisting of a deliverability rate, a digital message open rate, a click through rate, a conversion rate, a purchase rate, a reply rate, and an unsubscribe rate, a deliverability rate during a predetermined time interval, a digital message open rate during a predetermined time interval, a click through rate during a predetermined time interval, a conversion rate during a predetermined time interval, a purchase rate during a predetermined time interval, a reply rate during a predetermined time interval, and an unsubscribe rate during a predetermined time interval.
